(19) United States
(12) Patent Application Publication
(10) Pub. No.: US 2026/0183775 A1
(43) Pub. Date: Jul. 2, 2026

(54) MICRODOSING DEVICE AND METHOD FOR DISPENSING DROPLETS FROM A PLURALITY OF NOZZLES

(71) Applicant: Hamilton Freiburg GmbH, Freiburg i. Br. (DE)

(72) Inventors: Nils LASS, Freiburg i. Br. (DE); Andreas ERNST, Freiburg i. Br. (DE); Lutz RIEGGER, Freiburg i. Br. (DE)

(73) Assignee: Hamilton Freiburg GmbH, Freiburg i. Br. (DE)

(21) Appl. No.: 19/548,888

(22) Filed: Feb. 24, 2026

Related U.S. Application Data
(63) Continuation of application No. PCT/EP2024/074151, filed on Aug. 29, 2024.

(30) Foreign Application Priority Data
Aug. 30, 2023 (DE) 102023208320.5

(51) Int. Cl. B05B 1/30; B05B 1/02; B05D 1/30; B01L 3/00

(52) U.S. Cl. CPC B05B 1/3006; B05B 1/02; B05D 1/30; B01L 3/502707

(57) ABSTRACT

A microdosing device and a method for dispensing droplets from a plurality of nozzles are presented. The microdosing device comprises a cartridge, in which at least a part of a dosing chamber and the plurality of nozzles are formed, wherein the dosing chamber is fluidically connected to a fluid inlet and the plurality of nozzles. The microdosing device further comprises an actuator which is configured to change a volume of the dosing chamber to thereby eject a droplet from each of the plurality of nozzles, and a pressure sensor which is configured to generate a pressure signal dependent on a pressure in the dosing chamber. In addition, the microdosing device comprises a liquid reservoir which is fluidically connected to the fluid inlet, and a pressure control device provided separately from the actuator which is configured to control a pressure in the liquid reservoir on the basis of the pressure signal.

### CROSS-REFERENCE TO RELATED APPLICATIONS

This application is a continuation of copending International Application No. PCT/EP2024/074151, file August 29, 2024, which is incorporated herein by reference in its entirety, and additionally claims priority from German Application No. 102023208320.5, filed August 30, 2023, which is also incorporated herein by reference in its entirety.

### TECHNICAL FIELD

The present invention relates to devices and methods for dispensing droplets from a plurality of nozzles, wherein a pressure control device is configured to control a pressure in a liquid reservoir on the basis of a pressure signal. In particular, the invention relates to such devices and methods which are suitable for coating microfluidic structures.

### BACKGROUND OF THE INVENTION

Many technical applications in areas such as industry, laboratories and medical technology require the dosing of liquids such as adhesives, oils, suspensions, solutions or reagents. In particular, a dosing quantity and a dispensing position of the liquid may play an important role. For example, the coating of surface portions requires the dosing of a liquid onto the surface portions to be coated. Due to advancing miniaturisation, this may require dispensing of droplets with a volume ranging from a few picoliters to a few microliters, for example.

The coating of small, clearly defined surface areas plays an important role in the field of "point-of-care" diagnostics, for example. Here, certain areas in microfluidic structures are coated with a very precisely defined amount of reagent on a clearly defined surface. During a test, these areas are brought into contact with the fluid to be tested, wherein either substances required for the test are dissolved or already labelled substances bind to the binding sites generated by the coating (e.g. immunoassay). Another application of microdosing is the coating or production of microneedle arrays. Microneedle arrays are used in the field of drug delivery and immunisation. A microneedle array has a large number of individual needles, up to a few micrometres in size, which are attached vertically to a carrier material or formed from the test carrier, for example. In microneedle array coating processes, each individual needle is usually coated with a specific amount of reagent. In the production of microneedle arrays, negative moulds of the final needle array structure can be filled with reagent-containing polymer solutions and moulded after curing.

Droplets are dispensed sequentially from a nozzle for coating, wherein the nozzle can be moved to different positions for droplet dispensing. Motion control may be complex and error-prone. Furthermore, sequential droplet dispensing may be time-consuming which may affect time-dependent reactions and reduce the throughput of coated surfaces.

The publication US 10,717,293 B2 discloses a liquid circulation device which comprises a liquid chamber configured to contain liquid to be supplied to a liquid discharging portion that discharges liquid, a circulation portion configured to circulate the liquid between the liquid chamber and the liquid discharging portion, a liquid replenishing portion configured to replenish liquid to the liquid chamber, a gas replenishing portion configured to replenish gas to the liquid chamber, a pressure detecting portion configured to detect the pressure of the liquid chamber, and a control portion configured to adjust the pressure of the liquid discharging portion by replenishing the liquid into the liquid chamber with the liquid replenishing portion and replenishing the gas into the liquid chamber with the gas replenishing portion.

The publication EP 1212133 B1 discloses a device for applying a plurality of microdroplets to a substrate which comprises a plurality of nozzle openings in a dosing head. In addition to a device for fixing a liquid column of a medium to be dosed at each nozzle opening, a pressure chamber is provided which can be filled with a buffer medium and is arranged in such a way that the buffer medium can simultaneously exert a pressure on the ends of the liquid columns spaced from the nozzle openings. Finally, a pressurising device is provided to pressurise the buffer medium in such a way that a plurality of microdroplets are simultaneously applied to the substrate through the plurality of nozzle openings.

The publication EP 1351766 B1 discloses a microdosing device which comprises a media reservoir for containing a liquid to be dosed, a nozzle which is connected to the media reservoir via a connecting channel and can be filled with the liquid to be dosed via the connecting channel, and a drive device for applying such a force to a liquid located in the media reservoir and the nozzle when the drive device is actuated that an essentially identical pressure is exerted on the liquid contained in the media reservoir and in the nozzle. Flow resistances of the connecting channel and the nozzle are configured in such a way that, when the drive device is actuated, a volume flow in the connecting channel is small compared to a volume flow in the nozzle which causes the liquid to be dispensed to be ejected from an ejection opening of the nozzle.

The publication WO 1999037400 A1 discloses a volume sensor-free microdosing device which comprises a pressure chamber which is at least partially bounded by a displacer, an actuating device for actuating the displacer, wherein the volume of the pressure chamber can be changed by actuating the displacer, a media reservoir connected to the pressure chamber and a control device. The control device drives the micro-dosing device in such a way that a movement of the displacer from a first position to a predetermined second position causes a small change in the volume of the pressure chamber volume per unit of time, wherein a volume of fluid is drawn into the pressure chamber in a first movement phase of the displacer and the same is expelled in a second phase.

The publication WO 1998036832 A1 discloses a microdosing device which comprises a pressure chamber which is at least partially delimited by a displacer, an actuating device for actuating the displacer, wherein the volume of the pressure chamber can be changed by actuating the displacer, a media reservoir which is fluidically connected to the pressure chamber via a first fluid line, and an outlet opening which is fluidically connected to the pressure chamber via a second fluid line. The microdosing device further has a device for detecting the respective position of the displacer and a control device connected to the actuating device and the device for detecting the position of the displacer, wherein the control device controls the actuating device on the basis of the detected position of the displacer or on the basis of positions of the displacer detected during at least one previous dosing cycle to cause the ejection of a defined volume of fluid from the outlet opening.

US 4383264 A discloses a device for forming and ejecting a controlled amount of liquid on demand, such as an ink droplet generating device, with a transducer deformation element for controlled deformation in response to an electrical signal, a nozzle housing containing a nozzle chamber having a nozzle opening at its front and a relatively larger opening at its rear, wherein the larger chamber opening is in direct communication with a liquid reservoir, wherein the transducer deformation element and the nozzle housing are closely positioned to provide a direct interaction between the deformation element and the nozzle chamber upon receipt of an electrical signal, wherein the interaction causes the generation of a liquid droplet or other controlled quantity of liquid. Advantageously, the geometry of the nozzle chamber and the deforming member are matched, and the deformation element is oriented to contact the nozzle chamber as it deforms, wherein this contact contributes to the generation of the controlled amount of liquid or the droplet ejected from the nozzle.

### SUMMARY

According to an embodiment, a microdosing device for dispensing droplets from a plurality of nozzles may have: a cartridge, in which at least a part of a dosing chamber and the plurality of nozzles are formed, wherein the dosing chamber is fluidically connected to a fluid inlet and the plurality of nozzles; an actuator which is configured to change a volume of the dosing chamber to thereby eject a droplet from each of the plurality of nozzles; a pressure sensor which is configured to generate a pressure signal dependent on a pressure in the dosing chamber; a liquid reservoir which is fluidically connected to the fluid inlet; a pressure control device provided separately from the actuator which is configured to control a pressure in the liquid reservoir on the basis of the pressure signal.

According to another embodiment, a method for dispensing droplets from a plurality of nozzles of a microdosing device, wherein the microdosing device has a cartridge, in which at least a part of a dosing chamber and the plurality of nozzles are formed, wherein the dosing chamber is fluidically connected to a fluid inlet and the plurality of nozzles, an actuator, a pressure control device provided separately from the actuator, a pressure sensor and a liquid reservoir fluidically connected to the fluid inlet, may have the steps of: generating, by means of the pressure sensor, a pressure signal dependent on a pressure in the dosing chamber; controlling, by means of the pressure control device, a pressure in the liquid reservoir on the basis of the pressure signal; and changing, by means of the actuator, a volume of the dosing chamber to thereby eject a droplet from each of the plurality of nozzles.

According to another embodiment, a microdosing device for dispensing droplets from a nozzle may have: a cartridge, in which at least a part of a dosing chamber and the nozzle are formed, wherein the dosing chamber is fluidically connected to a fluid inlet and the nozzle; an actuator which is configured to change a volume of the dosing chamber to thereby eject a droplet from the nozzle; a liquid reservoir which is fluidically connected to the fluid inlet by means of a first fluid conduit; a second fluid conduit, wherein a first end of the second fluid conduit is fluidically connected to the fluid outlet of the dosing chamber and a second end of the second fluid conduit is an outlet, wherein a first valve is arranged between the first end and the second end which, when closed, shuts off a flow in the second fluid conduit, wherein, when the first valve is closed, a volume fluidically coupled to the dosing chamber and otherwise closed is formed, and wherein the microdosing device has a pressure sensor which is arranged to detect a pressure in the closed volume and to generate a pressure signal dependent on a pressure in the dosing chamber; a pressure control device provided separately from the actuator which is configured to control a pressure in the liquid reservoir on the basis of the pressure signal.

Embodiments of the invention provide a microdosing device for dispensing droplets from a plurality of nozzles, which comprises a cartridge, in which at least a part of a dosing chamber and the plurality of nozzles are formed, wherein the dosing chamber is fluidically connected to a fluid inlet and the plurality of nozzles, an actuator which is configured to change a volume of the dosing chamber to thereby eject a droplet from each of the plurality of nozzles, a pressure sensor which is configured to generate a pressure signal dependent on a pressure in the dosing chamber, a liquid reservoir which is fluidically connected to the fluid inlet, and a pressure control device provided separately from the actuator which is configured to control a pressure in the liquid reservoir on the basis of the pressure signal.

Embodiments of the invention provide a method for dispensing droplets from a plurality of nozzles of a microdosing device, wherein the microdosing device comprises a cartridge, in which at least a part of a dosing chamber and the plurality of nozzles are formed, wherein the dosing chamber is fluidically connected to a fluid inlet and the plurality of nozzles, an actuator, a pressure control device provided separately from the actuator, a pressure sensor and a liquid reservoir fluidically connected to the fluid inlet, wherein the method comprises generating, by means of the pressure sensor, a pressure signal dependent on a pressure in the dosing chamber, controlling, by means of the pressure control device, a pressure in the liquid reservoir on the basis of the pressure signal, and changing, by means of the actuator, a volume of the dosing chamber to thereby eject a droplet from each of the plurality of nozzles.

The present invention is based on the realisation that ejecting droplets from a plurality of nozzles can enable the simultaneous coating of several surfaces without the need to move a single nozzle sequentially to a plurality of positions. If the large number of nozzles were to be provided in the form of several actuators, each with one actuator, the configuration would become very complex. A large number of actuators would increase the space required. Furthermore, synchronising the control of a large number of actuators is complex. Another problem is that a large number of actuators may have different output quantities (e.g. due to intrinsic error tolerances in the manufacture of the actuators and/or different wear rates). Particularly when dosing liquids that are used for chemical reactions or diagnostics, different dosing quantities may lead to impairments in technical processes. For example, chemical reactions may proceed incompletely or at different speeds, or comparability between coated surfaces may be reduced. It was recognised that by fluidically connecting a large number of nozzles to a (common) dosing chamber and deforming this (common) dosing chamber by means of an actuator, differences in the dosing behaviour of the large number of nozzles can be reduced. Furthermore, it was recognised that pressure control of a pressure of the liquid reservoir enables indirect control of the pressure in the dosing chamber, as the dosing chamber is fluidically connected to the liquid reservoir. A pressure signal that is dependent on the pressure in the dosing chamber is therefore suitable as a basis for controlling the pressure in the dosing chamber indirectly via the pressure in the liquid reservoir. Due to simultaneously dispensing droplets from a plurality of nozzles, the liquid in the liquid reservoir can decrease in large batches, wherein these changes in the hydrostatic pressure in the liquid reservoir can lead to large pressure changes in the dosing chamber. It was recognised that a dispensing behaviour of the nozzles (e.g. dispensing quantity and/or droplet size) can be dependent on pressure changes in the dosing chamber (for example due to changes in a liquid meniscus in the nozzles) and the pressure control makes it possible to compensate for pressure changes so that the dispensing behaviour of the nozzles can be improved. The microdosing device can therefore be realised more simply, with less complexity, with fewer components and/or more cost-effectively and can be controlled more easily. The control system can also make it possible to reduce the requirements for the nozzles and nozzle surfaces. For example, larger nozzle openings (which generate a lower capillary pressure) can be used and/or plasma activation of the surface can be dispensed with, as leakage of the liquid can be counteracted by the pressure control. A larger liquid reservoir and/or a larger quantity of liquid can also be used, as the associated increased hydrostatic pressure can be compensated for via the pressure control.

In examples, the microdosing device further has a first fluid conduit which fluidically connects the liquid reservoir to the fluid inlet, and a second fluid conduit, wherein a first end of the second fluid conduit is fluidically connected to the fluid outlet, and a second end of the second fluid conduit is an outlet which is not fluidically coupled back to the liquid reservoir, wherein a first valve is arranged between the first end and the second end which, when closed, shuts off a flow in the second fluid conduit.

The first and second fluid conduits allow a liquid to be directed from the liquid reservoir through the dosing chamber to the outlet. The dosing chamber can therefore be vented and excess liquid drained via the outlet instead of the nozzles. Filling can therefore take place more quickly and avoids or reduces unintentional leakage of the liquid from the nozzles and wetting of the outside of the nozzle wall. The first valve allows the second fluid conduit to be closed towards an external atmosphere, so that a pressure that is generated via the pressure control device can transferred to the dosing chamber and is not equalised via the second fluid conduit at the external atmosphere. As the outlet is not coupled back to the liquid reservoir, it is not necessary to take into account (e.g. using additional sensors) pressure changes or level changes due to a potential inflow of liquid from the outlet into the liquid reservoir. Furthermore, if the first valve is closed and there is no back coupling to the liquid reservoir, the pressure control device can reduce the pressure in the liquid reservoir (or even set a negative pressure in relation to the external atmosphere). This can provide a suction effect that reduces unintentional leakage of the liquid. Consequently, larger nozzle diameters can be used which have a lower capillary effect to hold the liquid in the nozzle.

In examples, when the first valve is closed, a volume is formed which is fluidically coupled to the dosing chamber and is otherwise closed, wherein the pressure sensor is arranged to detect a pressure in the closed volume.

It was recognised that the volume in the second fluid conduit is only influenced by the pressure of the dosing chamber when the rest of the volume is closed. A decrease in pressure in the dosing chamber therefore leads to a decrease in pressure in the volume. Since the pressure in the filled dosing chamber keeps liquid in the volume of the second fluid conduit, the liquid column and pressure conditions in the volume of the second fluid conduit do not change if the pressure in the dosing chamber is kept constant. Consequently, the pressure in the dosing chamber can be controlled towards a target value or into a target range if the pressure signal (detected in the volume of the second fluid conduit) is controlled towards a target value or into a target range. This type of control is uncomplicated, requires no knowledge of the actual pressure in the dosing chamber and allows the pressure sensor to be arranged separately from the dosing chamber. Furthermore, the volume enables a gas volume to be enclosed, wherein a pressure signal detected in the gas volume can also be controlled only to a target value or in a target range. Pressure detection in a gas volume enables more accurate detection of rapid pressure changes (compared to pressure detection on a liquid phase). The pressure signal therefore allows more precise pressure control. In the case of pressure detection in a gas volume, contact between the pressure sensor and the liquid can be avoided, so that the cleanability of the microdosing device can be improved and the risk of contamination reduced.

In examples, the liquid reservoir is fluidically coupled to the second fluid conduit via the dosing chamber, wherein a pressure at the fluid inlet of the dosing chamber on a liquid in the dosing chamber results in a liquid column in the second fluid conduit, wherein a height of the liquid column depends on the pressure in the liquid reservoir.

In pressure equilibrium (e.g. with no movement of the liquid in the dosing chamber), a total pressure in the second fluid conduit (from a sum of a hydrostatic pressure of the liquid column in the volume of the second fluid conduit and a gas pressure above the liquid column in the volume of the second fluid conduit) corresponds to a pressure in the dosing chamber as well as a total pressure in the liquid reservoir (from a sum of a hydrostatic pressure of the liquid column in the liquid reservoir and a gas pressure above the liquid column in the liquid reservoir). Therefore, a pressure (in the gas phase or liquid phase) in the volume of the second fluid conduit is representative of or dependent on the pressure in the dosing chamber and the liquid reservoir and can form a basis for controlling the pressure in the liquid reservoir.

In examples, the first fluid conduit has a second valve that is configured to shut off a flow in the first fluid conduit.

The second valve can be closed when the liquid reservoir is coupled to or decoupled from the first fluid conduit. Furthermore, the second valve can be closed to prevent the liquid from flowing unintentionally through the second fluid conduit or the nozzles, for example until the pressure control device has set a pressure that allows the dosing chamber to be filled or drained.

In examples, the pressure control device is configured to control the pressure in the liquid reservoir on the basis of the pressure signal in such a way that the pressure in the dosing chamber and/or the pressure signal of the pressure sensor assumes a target value or is maintained within a target range.

The target value or target range of the pressure in the dosing chamber can, for example, be set in such a way that the liquid is prevented from leaking from the nozzles and/or a certain meniscus is created in the nozzles. As a result, requirements for the geometry of the nozzles (e.g. nozzle length and/or nozzle diameter) can be reduced. For example, large nozzles may have too little capillary force to hold the liquids, wherein controlling the pressure to a target value or target range can enable a suction effect that reduces leakage from the nozzles. Controlling to a specific meniscus improves the accuracy of droplet dispensing, while pressure control makes it possible, for example, to respond better to pressure drops during simultaneous ejection from the plurality of nozzles. For certain pressure sensor arrangements (such as in the volume of the second fluid conduit or in the nozzle chamber), controlling the pressure in the dosing chamber to a target value or within a target range can be realised by controlling the pressure signal to a target value or within a target range. Controlling to a target value or target range of the pressure signal is uncomplicated, less error-prone and is not (or at least less) dependent on other parameters such as liquid density, a liquid level or a form of different volumes in the microdosing device.

In examples, the microdosing device further has a meniscus sensor configured to generate a meniscus signal dependent on a meniscus of at least one of the plurality of nozzles, wherein the pressure control device is configured to control the pressure in the liquid reservoir on the basis of the meniscus signal.

Pressure control on the basis of the meniscus signal makes it possible to set a meniscus which improves dispensing droplets (e.g. to obtain a desired droplet size or dispensing volume) without having to determine a relationship between pressure signal and meniscus in advance (e.g. via experiments or simulations). Therefore, liquids can be used for which such a relationship is not known. Furthermore, the meniscus signal is representative of current operating conditions and therefore allows more precise control of the meniscus (e.g. if the meniscus can fluctuate due to external parameters such as temperature or atmospheric pressure). In addition, pressure control on the basis of the meniscus signal allows a target value or target range for the pressure signal and/or the pressure in the dosing chamber to be adjusted if deviations occur (e.g. due to changed operating conditions or errors in generating the pressure signal or controlling the pressure in the liquid reservoir).

In examples, the pressure control device or a control of the microdosing device connected to the pressure control device is configured to determine and/or adjust the target value or target range for the pressure in the dosing chamber and/or for the pressure signal on the basis of the meniscus signal.

The pressure control device or control may have an algorithm or method for determining and/or adjusting the respective target value or target range. For this purpose, the pressure control device or control may be configured to instruct the pressure sensor to generate and/or provide the pressure signal. The pressure control device or control may, for example, assign a value (or data set) of the meniscus signal to different values of the pressure signal. The pressure control device or control may be configured to use criteria (e.g. meniscus shape and/or drop volume) to identify a target meniscus or optimised meniscus. Optionally or additionally, information (e.g. image data of the meniscus and/or the droplets, a volume specification of the droplets or a meniscus curvature) via the meniscus signal may be provided to a user which enables the user to select a desired meniscus (or a pressure signal assigned to it).

In examples, the pressure control device has at least one of a gas pump which is configured to change a gas pressure in the liquid reservoir and a liquid pump which is configured to refill liquid into the liquid reservoir.

It was recognised that the pressure in the dosing chamber depends on a hydrostatic pressure of the liquid in the liquid reservoir and a gas pressure above the liquid in the liquid reservoir. Consequently, the pressure control by the gas pump and/or the liquid pump can control the pressure in the liquid reservoir (and thus indirectly the pressure in the dosing chamber). The gas pump can also be used to fill (e.g. by increasing the pressure) and/or drain (e.g. by reducing the pressure) the liquid reservoir.

In examples, the microdosing device (or actuator) further has a plunger, wherein the actuator is configured to change the volume of the dosing chamber by means of a movement of the plunger.

The plunger forms a solid body that can be moved as a whole. Consequently, the plunger can generate a directed pressure pulse in the liquid which depends on a surface of the plunger. For example, the plunger may have a flat end face so that a pressure pulse (or pressure impulse or pressure peak) is distributed more evenly across the nozzles. A deflection of a vibrating plate, on the other hand, the deflection of which decreases towards an edge attachment can, for example, lead to a wave-shaped pressure pulse which can lead to a greater variance in the droplet dispension with a plurality of nozzles. However, the end face of the plunger is better suited to transmitting a more even (or constant) pressure impulse to the plurality of nozzles.

In examples, the plunger is sealed against the cartridge with a seal (e.g. with an O-ring or a diaphragm).

The seal reduces the risk of liquid entering the dosing chamber between the plunger and the cartridge (e.g. a cartridge body). As a result, pressure drops due to entering can be reduced and impairment or damage to liquid-sensitive components (e.g. electrical circuits) of the microdosing device can be avoided.

In examples, the plunger has a lateral surface and at least one of the fluid inlet and the fluid outlet is directed towards the lateral surface. For example, at least one of the fluid inlet and the fluid outlet may be arranged at a distance from the nozzle wall.

By changing the volume of the dosing chamber, the liquid in the dosing chamber can escape from openings in a delimitation of the dosing chamber. As a result, the liquid can escape from the nozzles, from the fluid inlet and (if present) from the fluid outlet. When the lateral surface is directed towards the fluid inlet and the fluid outlet, the plunger increases a fluidic resistance to the fluid inlet and the fluid outlet. As a result, (unwanted) leakage of the fluid from the fluid inlet and the fluid outlet can be reduced. The droplet dispension can therefore be better controlled and pressure damping via the fluid inlet and fluid outlet (e.g. by compressing gas volumes in the second fluid conduit and/or the liquid reservoir) can be reduced.

In examples, the plurality of nozzles is arranged in a nozzle region of a nozzle wall of the dosing chamber and the plunger has an end face which is larger than the nozzle region.

The end face of the plunger enables a more even distribution and/or orientation of pressure pulses in the liquid towards the nozzles. An end face which is larger than the nozzle region allows the entire nozzle region to be covered with the end face. The pressure pulse can therefore be more accurately directed across all nozzles.

In examples, the end face of the plunger is at least twice as large as the nozzle region, advantageously at least 2.7 times larger than the nozzle region.

As the area of the end face increases, a more homogeneous distribution of pressure pulses occurs in the centre of the end face. It was recognised that an end face that is at least twice as large as the nozzle region improves the compromise between the distribution of pressure pulses and the compactness of the microdosing device.

In examples, the nozzle region has an area with a size in a range of from 3 mm² to 12 mm², advantageously in a range from 6 mm² to 8 mm². Alternatively or additionally, the end face of the plunger has an area with a size in a range from 9 mm² to 31 mm², advantageously in a range from 15 mm² to 25 mm².

The nozzle region is therefore dimensioned to eject droplets in a pattern that allows, for example, microstructures for laboratory and point-of-care applications to be coated. The end face is dimensioned to improve the distribution of pressure pulses.

In examples, the plurality of nozzles is arranged in a nozzle wall and an end face of the plunger and the nozzle wall have a spacing in a range from 50 µm to 2000 µm, advantageously in a range from 200 µm to 600 µm. The plunger may protrude from a surface of the cartridge facing away from the nozzle wall.

The advantages of the end face of the plunger described above are more pronounced if the spacing between the end face and the nozzle wall is reduced (for example, because a smaller proportion of the pressure pulse leads to lateral fluid movement). It was recognised that a spacing in a range from 50 µm to 2000 µm improves a compromise between the direction of the pressure pulse and the stroke of the plunger. The pressure pulse of the plunger can be directed more precisely. If the plunger protrudes from the surface of the cartridge, the plunger can be positioned closer to the nozzle wall.

In examples, the microdosing device has a diaphragm which delimits at least a portion of the dosing chamber, wherein the actuator is configured to deform the diaphragm to change the volume of the dosing chamber.

The diaphragm forms a deformable delimitation and can improve the sealing between the cartridge and the actuator. Furthermore, when deformed, the diaphragm can essentially adopt a contour of the actuator (e.g. a flat end face of a plunger) and therefore transmit an identical or similar pressure impulse. The diaphragm can prevent contact between the actuator (e.g. the plunger) and the liquid, so that the risk of contamination of the liquid by the actuator can be reduced or avoided.

In examples, the cartridge has a wall element which delimits at least a part of the dosing chamber, wherein the actuator is configured to deform the wall element to change the volume of the dosing chamber.

The wall element forms a deformable delimitation and can improve the sealing between the cartridge and the actuator. Furthermore, the wall can be formed in one piece with a cartridge body of the cartridge and can therefore be manufactured easily. The wall element can prevent contact between the actuator (e.g. the plunger) and the liquid, so that the risk of contamination of the liquid by the actuator can be reduced or avoided.

In examples, the plurality of nozzles on a side facing away from the dosing chamber each have a diameter in a range from 0.01 mm to 0.5 mm, advantageously in a range from 0.03 mm to 0.1 mm, and/or the plurality of nozzles on a side facing the dosing chamber each have a diameter in a range from 0.01 mm to 0.5 mm, advantageously in a range from 0.1 mm to 0.2 mm.

It was recognised that such dimensions have a capillary effect that prevents or reduces the liquid from leaking out of the nozzles, either alone or in combination with the pressure control. Furthermore, the nozzles are large enough to detach droplets. Nozzles whose diameter (or cross-section) increases towards the dosing chamber also form a confusor which allows the speed of the liquid in the nozzles to be controlled (e.g. increased).

In examples, the microdosing device further has a control configured to receive the pressure signal of the pressure sensor and/or the meniscus signal of the meniscus sensor, and to generate, on the basis of the pressure signal and/or the meniscus signal, a pressure control signal for the pressure control device for controlling the pressure in the dosing chamber.

The control allows the execution of more complex processes that may be required to generate the pressure control signal (e.g. interpreting the pressure sensor and/or the meniscus signal, storing target values and storing comparison values) so that other components such as the pressure sensor, the meniscus sensor and the pressure control device have less computational complexity requirements. In addition, the control unit may be configured to control at least one of the actuator, the first valve and the second valve. The control can therefore make operating the microdosing device simpler and more time-efficient. The control may be configured to carry out the method steps described herein (e.g. by generating corresponding instructions).

In examples, the microdosing device further has a first device part which comprises the cartridge with the plurality of nozzles, and a second device part which comprises the actuator, wherein the first device part and the second device part are connected or connectable to each other in a detachable manner.

The plurality of nozzles allows simultaneous ejection of droplets in a pattern that corresponds to an arrangement of the nozzles. Since the cartridge (as part of the first device part) is detachably connected or connectable to the second device part and the cartridge has the nozzles, the cartridge can be exchanged with another cartridge that has a different configuration of the nozzles (e.g. number, arrangement or diameter of the nozzles). This means, for example, that different surface arrangements can be coated without having to replace the entire microdosing device. Furthermore, the cartridge may be configured as a consumable item that is disposed of after use (e.g. to reduce or avoid contamination between different liquids).

In examples of the method, the microdosing device comprises further a first fluid conductor fluidically connecting the liquid reservoir to the fluid inlet and a second fluid conductor, wherein a first end of the second fluid conductor is fluidically connected to a fluid outlet of the dosing chamber and a second end of the second fluid conductor represents an outlet that is not fluidically coupled back to the liquid reservoir, wherein a first valve is arranged between the first end and the second end, which, when closed, shuts off a flow in the second fluid conductor, wherein the method further comprises filling, with the first valve open, the dosing chamber with a liquid from the liquid reservoir and closing the first valve.

The second fluid conduit and the outlet can accelerate venting of the dosing chamber during filling. During filling, liquid (e.g. excess liquid) can be directed from the dosing chamber to the outlet (instead of through the nozzles). Potential air bubbles in the liquid can therefore be removed via the outlet instead of the nozzles (or directed into the volume of the second fluid conduit). Air bubbles increase a capacity in the fluidic system and can dampen a direct energy input into the liquid by the actuator (e.g. by compressing the gas in the air bubble). Furthermore, air bubbles may penetrate (or "clog") the nozzles and prevent wetting and filling of the nozzles. Therefore, transporting air bubbles into the second fluid conduit can improve the energy input and nozzle wetting.

In examples, filling the dosing chamber with the liquid from the liquid reservoir comprises controlling, by means of the pressure control device, a pressure in the liquid reservoir in such a way that the liquid is conveyed into the dosing chamber.

The pressure control device allows filling independent of gravity or capillary forces. The pressure control device therefore enables the filling process to be accelerated (e.g. to counteract capillary effects) and/or slowed down (e.g. to reduce or prevent the formation of bubbles). The pressure control also enables the filling process to be automated, for example by the control (e.g. in combination with at least one of the first valve, the second valve and the pressure sensor).

In examples, when the first valve is closed, a volume is formed which is fluidically coupled to the dosing chamber and is otherwise closed, wherein the method comprises detecting, by means of the pressure sensor, a pressure in the closed volume to generate the pressure signal.

As already discussed above, this enables a control that is uncomplicated, requires no knowledge of the actual pressure in the dosing chamber and allows the pressure sensor to be arranged separately from the dosing chamber. Furthermore, the volume enables a gas volume to be enclosed, wherein a pressure signal detected in the gas volume can also be controlled only to a target value or in a target range.

In examples, the method further comprises generating, by means of a meniscus sensor of the microdosing device, a meniscus signal dependent on a meniscus of at least one of the plurality of nozzles, and controlling, by means of the pressure control device, the pressure in the liquid reservoir on the basis of the pressure signal and the meniscus signal.

As already discussed above, droplet dispension (e.g. accuracy and/or reproducibility of a droplet size and/or dispension quantity) can be improved without the need to determine a relationship between the pressure signal and the meniscus in advance. Furthermore, the meniscus can be better and/or more easily controlled for various liquids. In addition, pressure control on the basis of the meniscus signal allows a target value or target range for the pressure signal and/or the pressure in the dosing chamber to be adjusted if deviations occur.

In examples, the volume of the dosing chamber is changed periodically at a frequency of up to 100 Hz, for example in a range from 10 Hz to 100 Hz, for example in a range from 50 Hz to 100 Hz, for example in a range from 25 Hz to 75 Hz.

Volume changes at these frequencies facilitate non-contact dosing (jetting), wherein the reproducibility of periodic ejection can be improved by pressure control. Furthermore, the resulting short pulse duration reduces the risk of significantly influencing the generation of the pressure signal.

Embodiments of the invention provide a microdosing device for dispensing droplets from a nozzle, which comprises a cartridge, in which at least a part of a dosing chamber and the nozzle are formed, wherein the dosing chamber is fluidically connected to a fluid inlet and the nozzle, an actuator which is configured to change a volume of the dosing chamber to thereby eject a droplet from the nozzle, a liquid reservoir which is fluidically connected to the fluid inlet by means of a first fluid conduit, a second fluid conduit, wherein a first end of the second fluid conduit is fluidically connected to the fluid outlet, and a second end of the second fluid conduit is an outlet, wherein a first valve is arranged between the first end and the second end which, when closed, shuts off a flow in the second fluid conduit, wherein, when the first valve is closed, a volume fluidically coupled to the dosing chamber and otherwise closed is formed, and wherein the microdosing device has a pressure sensor which is arranged to detect a pressure in the closed volume and to generate a pressure signal dependent on a pressure in the dosing chamber; a pressure control device provided separately from the actuator which is configured to control a pressure in the liquid reservoir on the basis of the pressure signal.

Controlling the pressure in the liquid reservoir on the basis of the pressure signal using the pressure control device can be realised in a straightforward manner, does not require any knowledge of the actual pressure in the dosing chamber and allows the pressure sensor to be arranged separately from the dosing chamber. Furthermore, the volume enables a gas volume to be enclosed, wherein a pressure signal detected in the gas volume can also be controlled only to a target value or in a target range. Pressure detection in a gas volume enables more accurate detection of rapid pressure changes (compared to pressure detection on a liquid phase). The pressure signal therefore allows more precise pressure control and enables actuators to be operated at a higher frequency. These advantages also apply to a cartridge with only one (single) nozzle.

Embodiments of the invention provide a cartridge for a microdosing device which comprises a cartridge body, a nozzle wall having a nozzle or a plurality of nozzles arranged in a nozzle portion of the nozzle wall, wherein the nozzle wall is formed in the cartridge body of the cartridge or a nozzle chip which is inserted into a nozzle chip receiving opening of the cartridge body. In a first variant, a recess extends from a surface opposite the nozzle wall through the cartridge body to the nozzle region in order to expose recess side ends of the nozzles, wherein the recess is configured to receive an actuator and to define a dosing chamber with the actuator. In a second variant, the recess extends to a deformable delimitation which fluidically separates the recess from a chamber structure, wherein the chamber structure extends through the cartridge body from the delimitation to the nozzle region in order to expose chamber structure side ends of the nozzles, wherein the chamber structure defines a dosing chamber. The cartridge comprises a fluid inlet which is fluidically connected to a first opening in a side wall of the dosing chamber, and a fluid outlet which is fluidically connected to a second opening in the side wall of the dosing chamber.

Since the recess or the chamber structure extends to the nozzle region, the side walls of the recess or the chamber structure are different from the nozzle wall. Therefore, the fluid inlet and the fluid outlet are provided separately from the nozzles and can facilitate filling the dosing chamber with a liquid (e.g. instead of filling only via the nozzles). As the openings are provided in the side wall of the recess or chamber structure, the fluidic connection to the fluid inlet and the fluid outlet can be realised independently of the nozzle wall. Consequently, the nozzle wall can be dimensioned independently of the fluid inlet and can therefore be better adapted to the nozzles (e.g. to define a length of the nozzles via a wall thickness of the nozzle wall). Since the nozzle wall does not have to have a fluidic connection to the fluid inlet and fluid outlet, the nozzle wall can be manufactured separately from the cartridge body and then connected to the cartridge body (e.g. during the manufacture of the cartridge or by a user). This can facilitate the manufacture of cartridges with different nozzle arrangements (e.g. for coating different microfluidic structures using different nozzle arrangements). The cartridge may be part of a first device part which is detachably connected or connectable to a second device part which comprises the actuator. Consequently, the cartridge can be detached and replaced with a new cartridge, for example to use a different liquid and/or a nozzle wall with different nozzles. This can reduce contamination of different liquids and change the droplet dispension (e.g. different droplet size and/or a different droplet distribution), for example to adapt to a different surface arrangement to be coated.

In examples, the cartridge has a first hose connection which is fluidically connected to the fluid inlet and configured to be connected to a first hose, and/or has a second hose connection which is fluidically connected to the fluid outlet and configured to be connected to a second hose.

The hose connections enable an uncomplicated fluidic connection to the liquid reservoir and/or the second fluid conduit. The cartridge may also have the first and second hoses, for example to prevent contamination of different liquids.

In examples, the cartridge has one or more attachment openings which extend through the cartridge body in a direction perpendicular to the nozzle wall and are fluidically connected to the recess, the fluid inlet and the fluid outlet not in the cartridge body.

The attachment openings can receive attachment elements of a second device part or an actuator which can facilitate positioning and orientation of the cartridge in relation to the actuator. Furthermore, the cartridge can be attached to the second device part and the actuator by means of the attachment openings.

In examples, a cross-sectional area of the recess parallel to the nozzle wall is at least twice as large as an area of the nozzle region, advantageously 2.7 times as large as the area of the nozzle region.

A cross-sectional area dimensioned in this way makes it possible to receive a similarly dimensioned plunger. This makes it possible, as described above, to improve a compromise between the distribution of pressure pulses and the compactness of the microdosing device.

In examples, the nozzle region has an area with a size in a range from 3 mm² to 12 mm², advantageously in a range from 6 mm² to 8 mm², and/or, a cross-sectional area of the recess has a size in a range from 9 mm² to 31 mm², advantageously in a range from 15 mm² to 25 mm².

The nozzle region is therefore dimensioned to eject droplets in a pattern that allows microstructures for laboratory and point-of-care applications to be coated. The recess is dimensioned to accommodate a plunger which may be configured to improve the distribution of pressure pulses.

In examples, the cartridge also has a liquid reservoir that is fluidically connected or connectable to the fluid inlet. The liquid reservoir may be filled with a liquid. Alternatively or additionally, the cartridge has a pressure sensor which is configured to generate a pressure signal dependent on a pressure in the dosing chamber (e.g. by means of a sensor surface in the recess, in the liquid reservoir or in a second fluid conduit which is fluidically connected to the fluid outlet).

The cartridge may be replaceable. Components that are part of the cartridge and may come into contact with a liquid can be replaced together with the cartridge so that liquid contamination can be reduced.

### BRIEF DESCRIPTION OF THE DRAWINGS

Examples of the present invention are explained in more detail below with reference to the accompanying drawings, in which:

FIG. 1a shows a schematic example of a microdosing device according to the invention;

FIG. 1b shows a further schematic example of a microdosing device according to the invention;

FIG. 2a shows a further example of a microdosing device according to the invention;

FIG. 2b shows a further example of a microdosing device according to the invention;

FIG. 3a shows a schematic example of a first variant of a cartridge for a microdosing device according to the invention;

FIG. 3b shows a schematic example of a second variant of a cartridge for a microdosing device according to the invention;

FIG. 4a shows a schematic cross-section of an example of a nozzle wall;

FIG. 4b shows a top view of the nozzle wall from FIG. 4a;

FIG. 5a shows a perspective view of an example of a cartridge;

FIG. 5b shows a perspective view of the cartridge from FIG. 5a obliquely from below;

FIG. 6a shows a perspective view of a cartridge according to a further example, in which the nozzle wall is removed;

FIG. 6b shows a perspective view of the cartridge from FIG. 6a with a nozzle wall;

FIG. 7a shows a schematic cross-section of the cartridge from FIG. 6a, b, wherein the plunger is arranged in an extended position;

FIG. 7b shows a schematic cross-section of the cartridge from FIG. 6a, b, wherein the plunger is arranged in a retracted position;

FIG. 8a shows a schematic cross-section of an example of a cartridge for dispensing droplets from a plurality of nozzles;

FIG. 8b shows a top view of the nozzle wall of the cartridge from FIG. 6a;

FIG. 9a shows a schematic cross-section of an example of a cartridge with an actuator;

FIG. 9b shows a schematic cross-section of an example of a cartridge from FIG. 8a, wherein the plunger is arranged in an extended position;

FIG. 9c shows a schematic cross-section of an example of a cartridge from FIG. 8a, wherein the plunger is arranged in a retracted position;

FIG. 10a shows a schematic cross-section of an example of a cartridge with openings spaced from the nozzle wall;

FIG. 10b shows a schematic cross-section of the cartridge from FIG. 10a, wherein the plunger is arranged in a retracted position;

FIG. 10c shows a schematic cross-section of an example of a cartridge of a second variant which has a deformable delimitation with a diaphragm;

FIG. 10d shows a schematic cross-section of an example of a cartridge from FIG. 10c, wherein the actuator is arranged in a retracted position;

FIG. 10e shows a schematic cross-section of an example of a cartridge of the second variant which has a deformable delimitation with a wall element;

FIG. 10f shows a schematic cross-section of the cartridge from FIG. 10e, wherein the actuator deforms the wall element;

FIG. 11 shows an example of a method for dispensing droplets from a plurality of nozzles of a microdosing device; and

FIG. 12 shows a schematic example of a microdosing device according to the invention for dispensing droplets from a nozzle.

### DETAILED DESCRIPTION OF THE INVENTION

In the following, examples of the present disclosure are described in detail using the accompanying drawings. It should be noted that identical elements or elements having the same functionality are provided with identical or similar reference signs, wherein a repeated description of elements provided with the same or similar reference sign are typically omitted. In particular, identical or similar elements may each be provided with reference signs that have the same number with a different or no lower case letter. Descriptions of elements that have the same or similar reference signs may be interchangeable. In the following description, many details are described to provide a more thorough explanation of examples of the disclosure. However, it is obvious to experts that other examples may be implemented without these specific details. Features of the different examples described can be combined with each other, unless features of a corresponding combination are mutually exclusive or such a combination is expressly excluded.

Before explaining examples of the present disclosure in more detail, definitions of some terms used herein are provided.

The term “liquid” as used herein includes, as is obvious to those skilled in the art, in particular liquids containing solid components, such as suspensions, biological samples and reagents.

The terms fluidic connection or fluidic coupling as used herein include, in particular, connections between two or more volumes that enable a fluid (e.g. a gas or a liquid) to be transported between the two or more volumes. A fluidic connection between a first volume and a second volume allows, for example, a liquid to be urged (e.g. by pressurisation) from one of the two volumes into the other of the two volumes. A fluidic connection may have at least one of a hose, a tube and a wall opening between two volumes.

The term "comprise" as used herein refers to the presence of features, wherein the presence of further features is not excluded.

Examples of the invention may be used in particular in the field of microdosing, which involves the processing of liquids in the picoliter to milliliter range. Accordingly, the fluidic structures may have suitable dimensions in the micrometre range for handling corresponding liquid volumes.

Unless otherwise specified herein, room temperature (20 °C) shall be assumed for temperature-dependent variables.

Negative pressure is defined here as the pressure difference between the ambient pressure (usually atmospheric pressure: patm ~1013 hPa) and a generated lower pressure (< patm).

Examples of the present disclosure provide a microdosing device and a method for dispensing droplets from a plurality of nozzles of the microdosing device, in particular structures and methods.

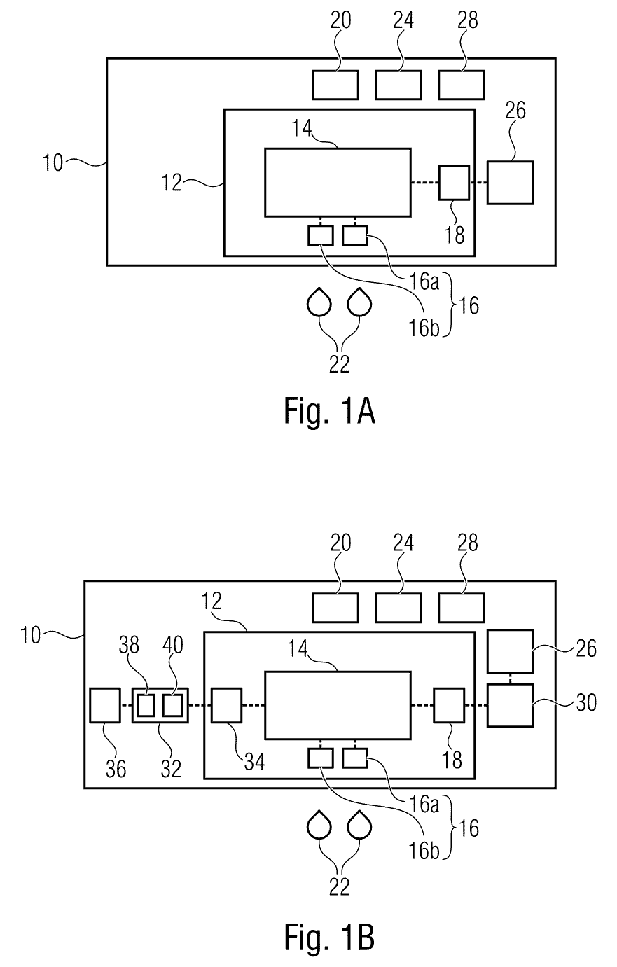

FIG. 1a shows a schematic example of a microdosing device 10 according to the invention.

The microdosing device 10 comprises a cartridge 12 in which at least a part of a dosing chamber 14 and the plurality of nozzles 16 are formed, wherein the dosing chamber 14 is fluidically connected to a fluid inlet 18 and the plurality of nozzles 16. In FIG. 1a, the fluidic connection (or coupling) between the dosing chamber 14 and the fluid inlet 18 and the plurality of nozzles 16 is indicated by dashed lines. FIG. 1a shows an example of two nozzles 16a, 16b. However, the plurality of nozzles 16 may have a larger number of nozzles 16. The fluid inlet 18 is provided separately from the nozzles 16.

The microdosing device 10 comprises an actuator 20 configured to change a volume of the dosing chamber 14 to thereby (i.e., through the volume change) eject a droplet 22 from each of the plurality of nozzles 16. The actuator 20 may comprise or form a single actuator or an actuator with a single movable actuating element (e.g. a plunger, a diaphragm, a lever or cantilever) for changing the volume of the dosing chamber 14. The droplets can be ejected from the plurality of nozzles 16 by actuating or moving the single (or common) actuator or actuating element. The actuator 20 may have at least one of an electric motor, piezoelectric elements, a plunger, a diaphragm and a cantilever. The actuator 20 may have a detachably connectable or couplable (e.g. by means of a magnetic coupling) plunger element. The actuator 20 may, for example, have an actuating element to which the plunger element can be magnetically coupled. The actuator 14 may be limited in its movement (e.g. have such a limited stroke) that it cannot close and/or touch the nozzles 16. Alternatively, the actuator 14 may be configured to touch and/or close the nozzles 16.

The microdosing device 10 comprises a pressure sensor 24 which is configured to generate a pressure signal dependent on a pressure in the dosing chamber 14, and a liquid reservoir 26 which is fluidically connected to the fluid inlet 18. The pressure sensor 24 may, for example, have a sensor surface that is configured to detect a gas pressure and/or a liquid pressure.

The microdosing device 10 also comprises a pressure control device 28 (e.g. fluid displacement device) provided separately from the actuator 20 which is configured to control a pressure in the liquid reservoir 26 on the basis of the pressure signal. The pressure control device 28 may be provided separately from the actuator 20. The pressure control device 28 may be arranged outside the dosing chamber 14 (e.g. outside the cartridge 12) and may be coupled and/or couplable, for example, to the liquid reservoir 26 (e.g. to an internal volume of the liquid reservoir 26). The pressure control device 28 may be configured to control the pressure in the liquid reservoir 26 independently of an operation and/or a stroke of the actuator 14 (e.g. configured to be able to increase a pressure without having to move the actuator 14 and/or having to know a stroke of the actuator). The liquid reservoir 26 may have an internal volume for receiving a liquid, wherein the pressure control device 28 may be configured to control a pressure of a gas phase and/or liquid phase in the internal volume of the liquid reservoir 26. The pressure control device 28 may be configured to supply and/or discharge gas (e.g. air) and/or liquid through a reservoir access (e.g. provided separately from a first and/or second fluid conduit 30, 32).

In order to supply the dosing chamber 14 (e.g. a print head for dispensing droplets 22 in a pattern that is predetermined by an arrangement of the nozzles 16) with liquid, the fluid inlet 18 (e.g. an inlet channel) is fluidically connected to the liquid reservoir 26, for example, in which a liquid to be dosed is stored. Depending on the positioning of the liquid reservoir 26 relative to a position of the dosing chamber 14 (e.g. a nozzle wall or a nozzle chip), a fill level in the liquid reservoir 26 generates a hydrostatic pressure which acts on the nozzles 16 (e.g. dosing nozzles) (e.g., system pressure) and defines or influences a fluid meniscus in the individual nozzles 16. As this meniscus can have a significant influence on droplet generation, it is advantageous if the system pressure can be kept constant (e.g. at a target value or within a target range). The hydrostatic pressure which changes due to a decrease in the fill level during repeated droplet dispensing (e.g. during longer coating processes), can therefore be compensated for. Since droplet dispension from a plurality of nozzles 16 can be realised by actuating a single actuator 20, scaling up the number of nozzles 16 can be facilitated. The number of nozzles 16 may, for example, be in a range from 2 to 1000, e.g. in a range from 10 to 500, e.g. in a range from 50 to 200, e.g. in a range of several dozen nozzles 16. However, a droplet output from, for example, 200 nozzles 16 does not require providing 200 actuators but only one actuator 20. In this way, a compromise between the number of nozzles and the complexity of the microdosing device 10 can be improved.

FIG. 1b shows a further schematic example of a microdosing device 10 according to the invention.

The microdosing device 10 has a cartridge 12, an actuator 20, a pressure sensor 24, a liquid reservoir 26, and a pressure control device 28, wherein any of these components may be implemented in any configuration described herein in combination with any other component described herein.

The microdosing device 10 further has a first fluid conduit 30 fluidically connecting the liquid reservoir 26 to the fluid inlet 18, and a second fluid conduit 32 (provided separately from the first fluid conduit 30), wherein a first end of the second fluid conduit 32 is fluidically connected to a fluid outlet 34 (provided separately from the fluid inlet 18 and the nozzles 16) of the dosing chamber 14 and a second end of the second fluid conduit 32 is an outlet 36 which is not fluidically coupled back to the liquid reservoir 26. For example, the second end of the second fluid conduit 32 is not coupled back to the liquid reservoir 26 in such a way that the outlet 36 opens into the liquid reservoir 26 (for example via a liquid pump). Instead, the second end of the second fluid conduit 32 is only indirectly fluidically connected to the liquid reservoir 24 via (a diversion through) the dosing chamber 14. For example, the microdosing device 10 has only those fluidic lines between the second end of the second fluid conduit 32 and the liquid reservoir 26 that extend through the dosing chamber 14.

The outlet 36 can be used for venting the dosing chamber 14 (e.g. when filling with liquid) and/or for draining excess liquid (wherein a capillary pressure in the nozzles 16 can prevent excess liquid from escaping from the nozzles 16). Since the outlet 36 is not coupled back to the liquid reservoir 26, the liquid can be directed from the liquid reservoir 26 through the dosing chamber 14 (and not through a back coupling) to the outlet 36, for example until the liquid begins to exit the outlet. In this way, the dosing chamber 14 can be filled with the liquid.

The outlet 36 may be a line end or pipe end that leads into a free space outside the microdosing device 10.

A first valve 38 is disposed between the first end and the second end which, when closed, shuts off a flow in the second fluid conduit 32. The valve 38 can be used to end a venting process and/or drain excess fluid.

As will be described below, the first valve 38 can also be used to form a volume 40 in which the pressure sensor 24 can detect a pressure.

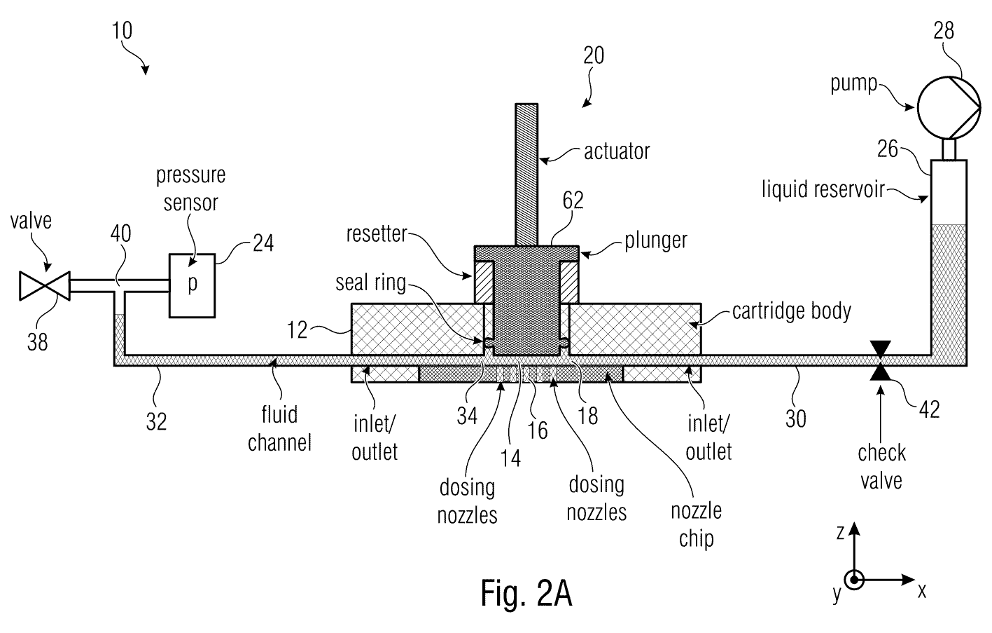

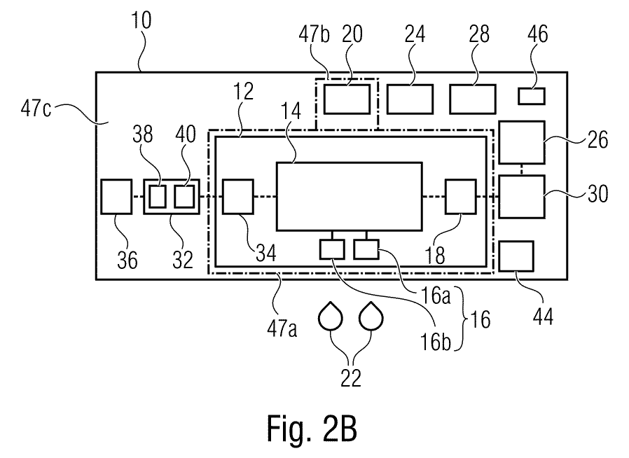

FIG. 2a shows a further example of a microdosing device 10 according to the invention.

The microdosing device 10 has a cartridge 12, an actuator 20, a pressure sensor 24, a liquid reservoir 26, and a pressure control device 28, wherein any of these components may be implemented in any configuration described herein in combination with any other component described herein.

The microdosing device 10 has a first fluid conduit 30 which fluidically connects the liquid reservoir 26 to the fluid inlet 18, and a second fluid conduit 32, wherein a first end of the second fluid conduit is fluidically connected to a fluid outlet 34 of the dosing chamber 14 and a second end of the second fluid conduit 32 is an outlet 36 which is not fluidically coupled back to the liquid reservoir 26.

When the first valve 38 is closed, a volume 40 fluidically coupled to the dosing chamber 14 and otherwise closed can be formed, wherein the pressure sensor 24 is arranged to detect a pressure in the closed volume 40. The volume 40 can be defined as a volume that a fluid (e.g. a gas and/or liquid) can fill between the first valve 38 and the fluid outlet 34. Since the volume is fluidically coupled to the dosing chamber 14 and is otherwise closed, a pressure (e.g. positive pressure and/or negative pressure) can be built up in the volume 40 which is dependent on the pressure prevailing in the dosing chamber 14.

The dependence of the pressure in the volume 40 on the pressure in the dosing chamber 14 is described by way of example in three cases below.

In a first case, the dosing chamber 14 and the second fluid conduit 32 are only filled with a gas. This results in the same gas pressure in the volume 40 as in the dosing chamber 14. In this case, the pressure detected by the pressure sensor 24 in the volume 40 (essentially) corresponds to the pressure in the dosing chamber 14.

In a second case, the dosing chamber 14 and the second fluid conduit 32 are completely filled with a liquid. A hydrostatic pressure is created in the liquid in the second fluid conduit 32 which has the same pressure at a height (in the gravitational field of the earth) of the dosing chamber 14 as a pressure in the liquid in the dosing chamber 14. At a height above the dosing chamber 14, the pressure is lower than in the dosing chamber due to the difference in height. In this case, the pressure in the volume 40 detected by the pressure sensor 24 corresponds (essentially) to a pressure difference between the pressure in the dosing chamber 14 and a hydrostatic pressure resulting from a height difference between the dosing chamber 14 and the pressure sensor 24 (or its sensor surface).

In a third case, the dosing chamber 14 is filled with liquid and the volume 40 has a gas volume (e.g. of air). Due to the pressure in the dosing chamber 14, the liquid partially enters in the second fluid conduit 32 and creates a liquid column which compresses the gas volume. The pressure in the liquid column corresponds to the pressure in the dosing chamber 14 at the height of the dosing chamber 14 and decreases with increasing height due to the hydrostatic pressure. The pressure in the gas volume corresponds (essentially) to the hydrostatic pressure at the surface of the liquid column. In this case, a pressure in the volume 40 detected by the pressure sensor 24 in the gas volume corresponds (essentially) to a pressure difference between the pressure in the dosing chamber 14 and a hydrostatic pressure of a liquid column above the height of the dosing chamber 14. If the pressure sensor 24 (or its sensor surface) detects a pressure within the liquid column, the pressure in the volume 40 detected by the pressure sensor 24 corresponds (substantially) to a pressure difference from the pressure in the dosing chamber 14 and a hydrostatic pressure from a height difference between the dosing chamber 14 and the pressure sensor 24 (or its sensor surface).

In all three cases, the pressure signal is dependent on or representative of the pressure in the dosing chamber 14. The three cases described above serve to illustrate the dependency between the pressure sensor signal and the pressure in the dosing chamber 14. Idealised conditions were used that neglect other influences such as capillary forces, deformation of fluid conduits or vibrations (e.g. from actuator 20). Deviations from the idealised conditions are therefore conceivable.

The second fluid conduit 32 may be formed and/or have structures to form a volume of gas in the second fluid conduit 32 (or volume 40) when the second fluid conduit 32 is filled (e.g. to the first valve 38 or to the outlet 36) with a liquid, wherein the volume of gas is adjacent to the filled liquid (e.g. such that a change in a quantity of liquid in the second fluid conduit 32 may cause a change in pressure in the volume of gas). For example, the second fluid conduit 32 may have a branching, wherein one branch of the branching leads to the first valve 38 and a second branch of the branching has a closed (e.g. dead or blind) end. FIG. 2a shows such a branching, for example. Since the branch to the pressure sensor 24 is a closed end, a gas in it is not displaced by the liquid and a gas volume adjacent to the liquid is created. The pressure sensor 32 (or its sensor surface) may be arranged in the further branch. The second fluid conduit 32 allows forming a gas volume and the implementation of a gas sensor as a pressure sensor 24.

In the example shown in FIG. 2a, the liquid reservoir 26 is fluidically coupled to the second fluid conduit via the dosing chamber 14, wherein a pressure at the fluid inlet 18 of the dosing chamber 14 on a liquid in the dosing chamber 14 results in a liquid column in the second fluid conduit 32, wherein a height of the liquid column depends on the pressure in the liquid reservoir 26. The liquid reservoir 26 has an elongated container with a fluidic connection to the fluid inlet 18 at the bottom. The second fluid conduit 32 has a portion (shown vertically in FIG. 2a) that is orientated parallel to the elongated container of the liquid reservoir 26. Therefore, a liquid column in the liquid reservoir 26 in the dosing chamber 14 can generate a pressure that also generates a liquid column in the parallel portion of the second fluid conduit 32. However, the portion of the second fluid conduit 32 and the elongated container of the liquid reservoir 26 may be oriented differently (e.g. include an angle less than 90° or 45°). Generally, the second fluid conduit 32, the dosing chamber 14 and the liquid reservoir 26 may be arranged relative to each other such that the dosing chamber 14 can be positioned in the gravitational field of the earth below at least a part of the second fluid conduit 32 and the liquid reservoir 26.

The first fluid conduit has a second valve 42 which is configured to shut off a flow in the first fluid conduit 30. At least one of the first and second valves 38, 42 may be configured to be controlled by an electrical signal (e.g. to open and close the respective valve 38, 42). Alternatively or additionally, at least one of the first and second valves 38, 42 may be configured to be controlled manually.

FIG. 2b shows a further example of a microdosing device 10 according to the invention.

The microdosing device 10 has a cartridge 12, an actuator 20, a pressure sensor 24, a liquid reservoir 26, and a pressure control device 28, wherein any of these components may be implemented in any configuration described herein in combination with any other component described herein.

The microdosing device 10 further has a meniscus sensor 44 configured to generate a meniscus signal dependent on a meniscus of at least one (or all) of the plurality of nozzles 16. The meniscus sensor 44 may have electrodes which are arranged within or on one or more nozzles 16, wherein the meniscus may be detected capacitively, for example. Alternatively or additionally, the meniscus sensor 44 may comprise an optical sensor (e.g. one or more cameras), which is configured to generate image data (which comprise e.g. one or more images and/or a video) of the meniscus and/or ejected droplets 22 of one or more nozzles 16. The meniscus sensor 44 may be configured to determine the meniscus in the image data and/or to determine whether the meniscus corresponds to a target meniscus or lies within a target region of the meniscus. The meniscus can be determined directly via image data of a meniscus at a nozzle 16 or indirectly via a size and/or number of ejected droplets. For this purpose, a nozzle 16 and/or a nozzle wall may be configured to be translucent, at least in certain regions. The meniscus sensor 44 may be configured to send at least one of the meniscus signal, the image data, the detected meniscus or a deviation from a target meniscus to the pressure control device 28 and/or a control 46.

The pressure control device 28 may be configured to receive the pressure signal (and optionally the meniscus signal) and determine how to control the pressure in the liquid reservoir 26 on the basis of the pressure signal. For example, the pressure control device 28 may have a computing unit (e.g. an integrated circuit, a processor, or a control loop) configured to determine a pressure control signal on the basis of the pressure signal (and optionally the meniscus signal) to control the pressure in the liquid reservoir 26.

Alternatively, the microdosing device 10 may have a control 46 configured to receive the pressure signal of the pressure sensor and/or the meniscus signal of the meniscus sensor and to generate, on the basis of the pressure signal and/or the meniscus signal, a pressure control signal for the pressure control device for controlling the pressure in the dosing chamber. The control 46 may comprise at least one of an integrated circuit, a processor, a computer and a (digital or analogue) control loop.

The control 46 may also be configured to control at least one of the pressure sensor 24, the actuator 20, the meniscus sensor 44, the first valve 38 and the second valve 42. The control may have one or more user interfaces (e.g. a display, a keyboard, a computer mouse or a touch screen) or can be coupled with them.

The microdosing device 10 may comprise a first device part 47a and a second device part 47b, wherein the first device part 47a has the cartridge 12 with the plurality of nozzles 16 and the second device part 47b has the actuator 20. The first device part 47a and the second device part 47b may be connected or connectable to each other in a detachable manner. The cartridge 12 can therefore be exchanged, for example to avoid contamination of different liquids and/or to use cartridges 12 with different properties (e.g. number of nozzles and/or nozzle arrangement). At least one of the liquid reservoir 26, the pressure sensor 24, the first fluid conduit 30, the second fluid conduit 32, the pressure control device 28, the meniscus sensor 44 and the control 46 may be a part of the first device part 47a. Similarly, at least one of the liquid reservoir 26, the pressure sensor 24, the first fluid conduit 30, the second fluid conduit 32, the pressure control device 28, the meniscus sensor 44 and the control 46 may be a part of the second device part 47b.

In the example shown in FIG. 2b, the microdosing device 10 has at least a third device part 47c with components (e.g. the meniscus sensor 44) of the microdosing device 10 that are not a part of the first and second device parts 47a, b. Alternatively, the microdosing device 10 may not have a third device part 47c and all components of the microdosing device 10 are a part of either the first device part 47a or the second device part 47b. The first and second device parts 47a, b may be directly detachably connected or connectable to each other (regardless of whether the microdosing device 10 has more than two device parts 47a, b). If the microdosing device 10 has a third device part 47c, the first and second device parts 47a, b may be detachably connected or connectable to each other indirectly by means of the third device part 47c. Separating the first device part 47a and the second device part 47b can thus be realised by separating the first and/or second device part 47a, b from the third device part 47c. The microdosing device 10 may have further (e.g. a fourth, fifth, etc.) device parts. It should be noted that FIG. 2b shows an exemplary distribution of components to the first and second device parts 47a, b and that other distributions as described herein are possible.

Various examples of cartridges 12 are described below. Each cartridge 12 described herein may be implemented as a component that is fixedly (or non-detachably) connected to the rest of the microdosing device 10, or as a part of the first device part 47a that is connected or connectable to the second device part 47b in a detachable manner.

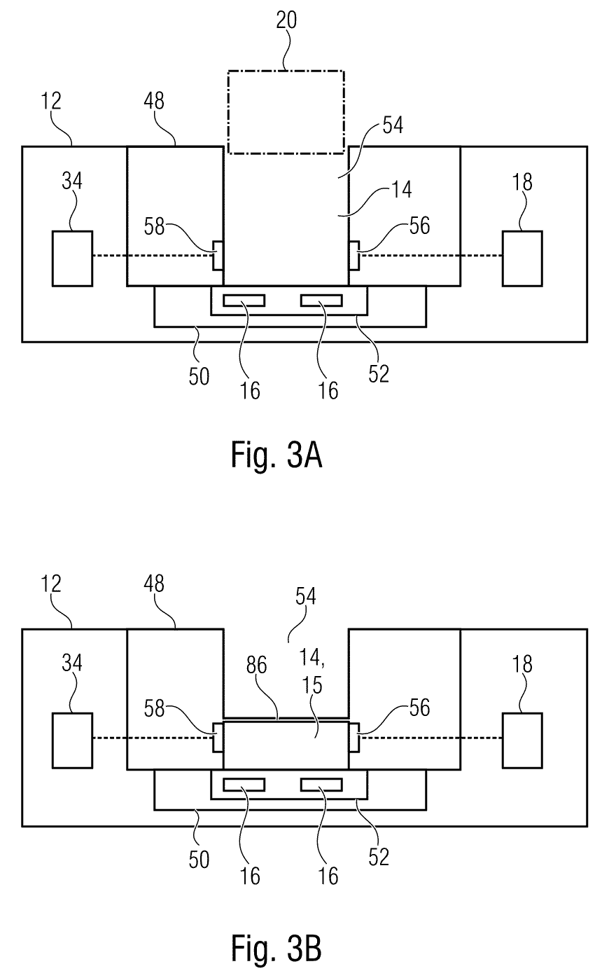

FIG. 3a shows a schematic example of a first variant of a cartridge 12 according to the invention for a microdosing device (e.g. microdosing devices 10, 90).

The cartridge 12 comprises a cartridge body 48 and a nozzle wall 50 with a nozzle or a plurality of nozzles 16 which are arranged in a nozzle region 52 (or nozzle window) of the nozzle wall 50, wherein the nozzle wall 50 is formed in the cartridge body 48 of the cartridge 12 or a nozzle chip (not shown in FIG. 3a) which is inserted into a nozzle chip receiving opening of the cartridge body 48. The nozzle region 52 may be a region defined by the nozzles 16. The nozzle region 52 may define a surface (e.g. facing a recess 54) on the nozzle wall 50 which forms a smallest convex surface and extends over the nozzles 16. For example, the nozzle wall 50 may have a rectangular arrangement of nozzles 16 which define a corresponding rectangular nozzle region 52.

The cartridge 12 further comprises a recess 54 which extends through the cartridge body 48 from a surface opposite the nozzle wall 50 to the nozzle region 52 to expose recess side ends of the nozzles 16, wherein the recess 54 is configured to receive an actuator 20 (shown dashed in FIG. 3a to illustrate that the actuator 20 needs not necessarily be a part of the cartridge 12) and to define a dosing chamber 14 with the actuator 20.

The cartridge 12 further comprises a fluid inlet 18 fluidically connected to a first opening 56 in a side wall (other than the nozzle wall) of the dosing chamber 14 (or the recess 54 exposing the nozzles 16), and a fluid outlet 34 fluidically connected to a second opening 58 in the side wall of the dosing chamber 14 (or the recess 54 exposing the nozzles 16). The first opening 56 may form the fluid inlet 18. The second opening 58 may form the fluid outlet 34.

The fluid inlet 18 and the fluid outlet 34 are provided separately from the nozzles 16 and can facilitate filling the dosing chamber 14 with a liquid (e.g. instead of filling only via the nozzles 16). Since the openings 56 and 58 are provided in the side wall of the recess 54, the fluidic connection to the fluid inlet 18 and the fluid outlet 34 can be realised independently of the nozzle wall 50 (e.g. without fluidic connection of the fluid inlet 18 through the nozzle wall 50 into the dosing chamber 14). Consequently, the nozzle wall 50 can be dimensioned independently of the fluid inlet 18 and can therefore be better adapted to the nozzles 16 (e.g. to define a length of the nozzles 16 via a wall thickness of the nozzle wall 50). Since the nozzle wall 50 does not need to have a fluidic connection to the fluid inlet 18 and fluid outlet 34, the nozzle wall 50 can be manufactured separately from the cartridge body and then connected to the cartridge body 48 (e.g. during the manufacture of the cartridge 12 or by a user). This can facilitate the manufacture of cartridges 12 with different nozzle arrangements (e.g. for coating different microfluidic structures using different nozzle arrangements).

The cartridge 12 may have a nozzle wall 50 in which the plurality of nozzles 16 are configured as continuous openings. The plurality of nozzles 16 may have an identical shape and/or identical size or may differ in this respect. The plurality of nozzles 16 may have a round, oval, square, rectangular or polygonal cross-section.

FIG. 3b shows a schematic example of a second variant of a cartridge 12 according to the invention. The second variant of the cartridge 12 may be implemented in any microdosing device described herein (such as the microdosing device 10 or the microdosing device 90).

The cartridge 12 comprises a cartridge body 48, a nozzle wall 50 with a nozzle or a plurality of nozzles 16 which are arranged in a nozzle region 52 of the nozzle wall 50, wherein the nozzle wall 50 is formed in the cartridge body 48 of the cartridge 12 or a nozzle chip 72 which is inserted into a nozzle chip receiving opening 74 of the cartridge body 48.

The cartridge 12 further has a recess 54 which extends through the cartridge body 48 from a surface 64 opposite the nozzle wall 50 to a deformable delimitation 86 which fluidically separates the recess 56 from a chamber structure 15, wherein the chamber structure 15 extends through the cartridge body 48 from the delimitation 86 to the nozzle region 52 to expose chamber structure side ends of the nozzles 16, wherein the chamber structure defines a dosing chamber 14. The cartridge 12 further has a fluid inlet 18 which is fluidically connected to the dosing chamber 14 via a first opening 56 in a side wall (different from the nozzle wall) of the chamber structure 15, and a fluid outlet 34 which is fluidically connected to the dosing chamber 14 via a second opening 58 in the side wall of the chamber structure 15.

The second variant of the cartridge 12 differs from the first variant essentially in the deformable delimitation 86. Therefore, both variants of the cartridge 12 may have any of the features described herein.

The first variant of the cartridge 12 has an uncomplicated and material-saving structure. The second variant of the cartridge 12 allows fluidic separation of the liquid from the actuator 20, so that contamination of the liquid by the actuator can be avoided.

The recess 56 and/or the chamber structure 15 may have a circular, square, rectangular or polygonal cross-section (parallel to the nozzle wall 50). The recess may have a cylindrical, cubic or cuboid shape, for example. The side wall of the recess 56 and/or the chamber structure 15 is different from the nozzle wall 50 (e.g. abutting and/or attached thereto). The side wall of the recess 56 and/or the chamber structure 15 may have wall parts (e.g. four mutually orthogonal wall parts in the case of a rectangular cross-section parallel to the nozzle wall), wherein the first and second openings 56, 58 may be arranged on different wall parts or on the same wall part.

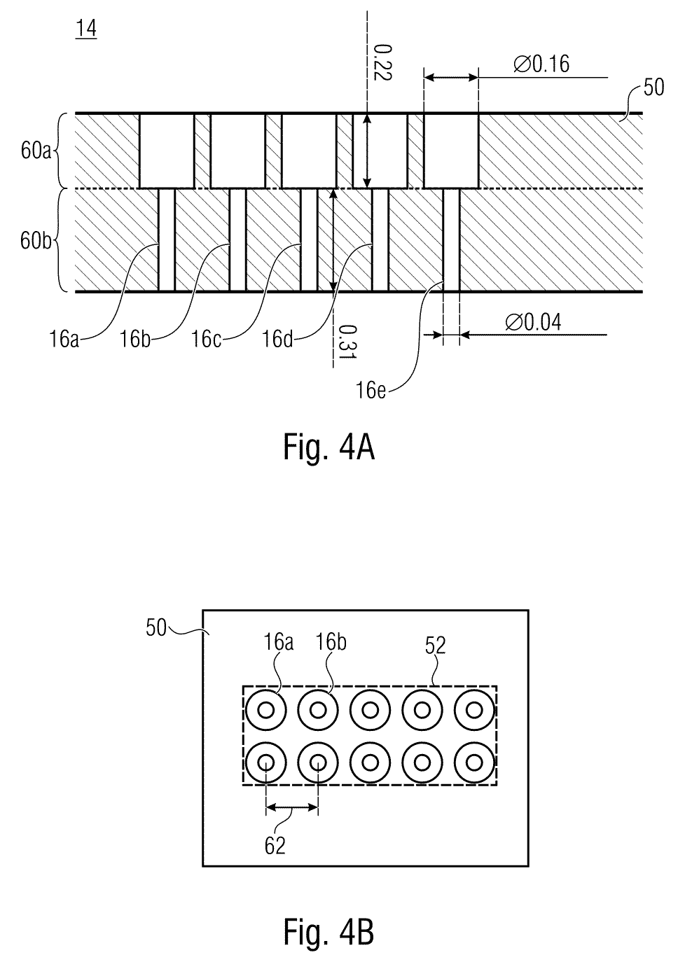

FIG. 4a shows a schematic cross-section of an example of a nozzle wall 50. The nozzle wall 50 shows five nozzles 16a-f as an example, but may have any other number of nozzles 16. The nozzles 16a-f are described below using nozzle 16a as an example. The remaining nozzles 16b-f may be configured identically or differently.

The nozzle 16a forms a continuous opening which penetrates the nozzle wall 50, wherein the opening extends in a straight line and perpendicular to the nozzle wall 50. In the example shown in FIG. 4a, the nozzle 16a has a first nozzle portion 60a along its extension through the nozzle wall 50 which is arranged on a side of the nozzle wall 50 facing the dosing chamber 14, and a second nozzle portion 60b which is arranged on a side of the nozzle wall 50 facing away from the dosing chamber 14. The first nozzle portion 60a has a larger cross-section than the second nozzle portion 60b. In the example shown in FIG. 4a, the first nozzle portion 60a has a diameter of 0.16 mm and the second nozzle portion has a diameter of 0.04 mm (e.g. in each case with a tolerance of ±10 % or ±20 %). Alternatively, the first nozzle portion 60a may have a diameter of 0.05 mm to 0.5 mm and the second nozzle portion 60b may have a diameter of 0.01 to 0.4 mm. At least one of the first portion 60a, the second nozzle portion 60b and an optional further nozzle portion between the first and second nozzle portions 60a, b may have a funnel shape. The first portion 60a has a length of 0.22 mm and the second portion 60b has a length of 0.31 mm (e.g. each with a tolerance of ±10 % or ±20 %). The nozzle wall 50 therefore has a wall thickness of 0.53 mm (e.g. with a tolerance of ±10 % or ±20 %). However, the nozzle wall 50 may also have a wall thickness in a range from 50 µm to 5 mm, e.g. in a range from 200 µm to 2 mm, e.g. in a range from 300 µm to 1 mm.

The nozzle wall 50 or a part thereof (e.g. in the region of the first and/or second nozzle portion 60a, b) may have a multi-layer structure (e.g. a sandwich structure). The nozzle wall 50 or a part thereof (e.g. in the region of the first and/or second nozzle portion 60a, b) may have a wafer including, for example, a semiconductor material (e.g. silicon and/or silicon oxide) and/or a glass (e.g. borosilicate glass, e.g. Pyrex). Manufacturing the nozzle wall 50 or a part thereof (e.g. in the region of the first and/or second nozzle portion 60a, b) may comprise one or more semiconductor process steps (e.g., photolithographic patterning, physical or chemical vapour deposition, dry or wet etching).

As the cross-section of the nozzle 16a decreases outwardly from the dosing chamber 14, the nozzle 16a may form a confusor to increase and/or control a velocity of dispensed droplets.

FIG. 4b shows a top view of the nozzle wall 50 from FIG. 4a.

In the example shown in FIG. 4b, the nozzle wall 50 has ten nozzles 16 (of which only five nozzles 16a-e are shown in FIG. 4a) which are arranged in a rectangular arrangement (or array) having two parallel rows of five nozzles 16 each. The nozzles 16 are arranged in a rectangular nozzle region 52 of the nozzle wall 50. The number of nozzles 16 may, for example, be in a range from 2 to 1000, e.g. in a range from 10 to 500, e.g. in a range from 50 to 200, e.g. in a range of several dozen nozzles 16. The nozzle region 52 may be defined by an (imaginary) frame around the outermost nozzles 16. The nozzle region 52 may have a geometric centre that coincides with an (elongated and imaginary) central axis of the recess 54 (e.g. an axis of a cylindrical shape of the recess 54) (e.g. within a tolerance of 1 mm). The nozzle region 52 may have a symmetrical (e.g. mirror-symmetrical and/or rotationally symmetrical) or an asymmetrical shape.

In the example shown in FIG. 4b, the nozzles have a nozzle spacing 62 (e.g. between the central axes of the nozzles 16a-e) of 0.28 mm (e.g. with a tolerance of ±10 % or ±20 %). The nozzles 16a-e may be arranged at a distance of 0.1 mm to 0.6 mm from each. The nozzles device 16 may also have a different arrangement. The arrangement may be periodic (e.g. a rectangular or hexagonal arrangement) or irregular (e.g. congruent with a microfluidic structure to be coated).

The arrangement of the nozzles 16 allows droplets 22 to be ejected in a pattern that reflects the arrangement of the nozzles. The arrangement of the nozzles 16 allows, for example, the coating of small, clearly defined surface areas of microfluidic structures (e.g. in the field of "point-of-care" diagnostics). Such microfluidic structures may, for example, have a microneedle array, the coating of which by a single-channel microdosing system would require repositioning of a single nozzle with respect to the microfluidic structure and sequential droplet dispension. Dispensing from the plurality of nozzles 16 allows simultaneous coating of several microfluidic structures and can improve the time efficiency of the coating process. The arrangement of the nozzles 16 may correspond to an arrangement of the microfluidic structures (e.g. an arrangement of needles of a microneedle array).

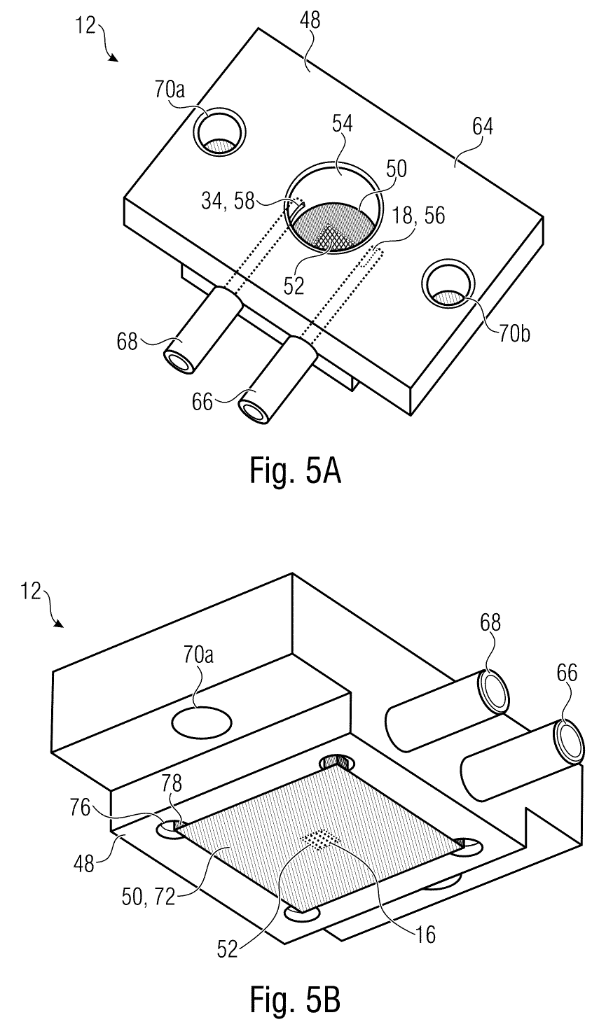

FIG. 5a shows a perspective view of an example of a cartridge 12 which can be used in any microdosing device described herein (for example in the microdosing device 10 of FIG. 1a).

The cartridge 12 has a nozzle wall 50 and a cartridge body 48. The cartridge 12 further comprises a recess 54 which extends through the cartridge body 48 from a surface 64 opposite the nozzle wall 50 to the nozzle region 52 to expose recess side ends of the nozzles 16. The recess 54 extends through the cartridge body 48 perpendicular to the nozzle wall 50 and has (at least in some regions) a constant cross-section perpendicular to the direction of extension. In the example shown in FIG. 5a, the recess 54 has a circular cylindrical shape. Alternatively, the recess 54 may have a different cross-section, such as a square or rectangular cross-section.

Since the recess 54 extends in a direction toward the nozzle wall 50, the actuator 20 (e.g. a plunger thereof) can move within the recess 54 toward and away from the nozzle wall 50 to change a volume of the dosing chamber 14. The recess 54 or the actuator 20 may have a seal (not shown in FIG. 5a) which allows the recess 54 to be sealed with respect to the actuator 20 (e.g. with respect to the plunger). The seal may have at least one of an O-ring, a guide ring, a wiper and sealing grease.

The cartridge 12 further comprises a fluid inlet 18 which is fluidically connected to a first opening 56 in a side wall of the dosing chamber (e.g. the recess 54), and a fluid outlet 34 which is fluidically connected to a second opening 58 in the side wall of the dosing chamber 14 (e.g. the recess 54).

The cartridge 12 has a first hose connection 66 which is fluidically connected to the fluid inlet 18 and is configured to be connected to a first hose (not shown in FIG. 5a). Furthermore, the cartridge has a second hose connection 68 which is fluidically connected to the fluid outlet 34 and is configured to be connected to a second hose (not shown in FIG. 5a).

The first opening 56 may form the fluid inlet 18 and the second opening 58 may form the fluid outlet 34. The fluidic connection between the first hose connection 66 and the first opening 56 may be limited to the first hose connection 66 and the first opening 56, such that no branching to an independent pressure volume, such as an outlet or a pressure pump, is provided therebetween. Similarly, the fluidic connection between the second hose connection 68 and the second opening 58 may be limited to the second hose connection 68 and the second opening 58. In this case, the first hose connection 66 may optionally be regarded as the fluid inlet 18 and the second hose connection 68 may be regarded as the fluid outlet 34. The fluidic connections to the first and second hose connections 66, 68 are shown (in the same way as in FIG. 1a) with dashed lines.

The hose connections 66, 68 have a cylindrical shape with a smooth surface. Alternatively, the hose connections 66, 68 may have corrugations. The hose connections 66, 68 are arranged on a common surface of the cartridge body 48 and parallel to each other. Alternatively, the hose connections 66, 68 may be arranged on different (e.g. opposite) surfaces of the cartridge body 48 and in different orientations relative to each other (e.g. perpendicular to each other or pointing away from each other).

In the example shown in FIG. 5a, the first and second openings 56, 58 are spaced apart from the nozzle wall 50 (e.g. at a distance of 0.1 mm to 1 mm). The plunger of the actuator 20 may have a lateral surface (e.g. a lateral surface of a cylindrical plunger) towards which the first and/or second openings 56, 58 is directed towards the lateral surface (e.g. in any position of the actuator 20 or at least in a position of the actuator 20 close to the nozzle wall 50).

When the actuator 20 (e.g. its plunger) is moved toward the nozzle wall 50, the plunger may partially or completely cover the first and/or second openings 56, 58 such that a fluidic resistance between the first and/or second openings 56, 58 and the dosing chamber 14 is increased. Consequently, displacement of the liquid through the first and/or second openings 56, 58 (in favour of displacement of the liquid through the nozzles 16) may be reduced.

A cross-sectional area of the recess 54 parallel to the nozzle wall 50 may be greater than or equal to the area of the nozzle region 52 (e.g. along its full extent from the surface 64 toward the nozzle wall 50 or toward the deformable delimitation 86). The recess 54 may be configured in such a way that the cartridge body 48 does not overlap with the nozzle region 52 on a side of the nozzle wall 50 facing the recess 54 in a direction parallel to the nozzle wall 50. Consequently, the recess may receive an actuator which has an end face that can cover the nozzle region 52. This can improve uniform liquid dispension through the nozzles 16 in the nozzle region 52.

In the example shown in FIG. 5a, the nozzle region 52 has a surface area of 7 mm² and a cross-sectional area of the recess 54 parallel to the nozzle wall has a size of 19 mm². Consequently, the cross-sectional area of the recess 54 parallel to the nozzle wall is 2.7 times (within a tolerance of ±10%) larger than the area of the nozzle region 52.

The cartridge 12 may be a part of the first device part 47a (or form the first device part 47a) and be provided separately from the second device part 47b which comprises an actuator. The first device part 47a may be configured to be detachably connected or coupled to the second device part 47b. The cartridge 12 may thus form a consumable or replaceable item, and the second device part 47b can be reused with different cartridges 12. The cartridge 12 can be replaced, for example, in order to use different nozzle arrangements. The cartridge 12 can be used as a consumable item. For example, a new cartridge 12 can be used to eject droplets of another liquid in order to reduce contamination between liquids.

The cartridge 12 has two attachment openings 70a, b which extend through the cartridge body 48 in a direction perpendicular to the nozzle wall 50 (or parallel to the direction of extension of the recess 54) and are fluidically connected to the recess 54, the fluid inlet 18 and the fluid outlet 34 not in the cartridge body 48. The attachment openings 70a, b may be configured to receive guiding structures and/or attachment structures. For example, screws or elongated attachments can be guided through the attachment openings 70a, b. The cartridge 12 can be locked in place by means of nuts on the screws (received in the attachment openings 70a, b) or with attachment elements on the attachments (received in the attachment openings 70a, b). In this way, the cartridge 12 can be (detachably) coupled (e.g. fastened) to the second device part 47b of a microdosing device.

The recess 54 is arranged between the attachment openings 70a, b. This allows lever forces on the cartridge 12 to be reduced when the actuator 20 is moved.

The cartridge 12 (or a first device part 47ba which comprises the cartridge 12) may comprise one or more hoses, each of which is detachably connected or connectable to the hose connectors 66, 68. Alternatively, the hoses may be non-detachably connected (e.g. by means of an adhesive and/or a fusion) to the hose connections 66, 68.

Further, the cartridge 12 may comprise at least one of a liquid reservoir 26, a pressure sensor 24, a seal (between the actuator 20 and the recess 54), a first valve 38 and a second valve 42 as described herein. Such a cartridge 12 makes it possible to reduce contamination between different liquids and to facilitate fluidic coupling of the nozzle chamber 14 with the liquid reservoir 24. Furthermore, the liquid reservoir 26 may have a predefined amount of liquid, for example to make it easier to monitor the fill level. The liquid reservoir may be fluidically connected or connectable to the fluid inlet (e.g. by means of a hose connected to the hose connection 66).

FIG. 5b shows a perspective view of the cartridge 12 of FIG. 5a from below.

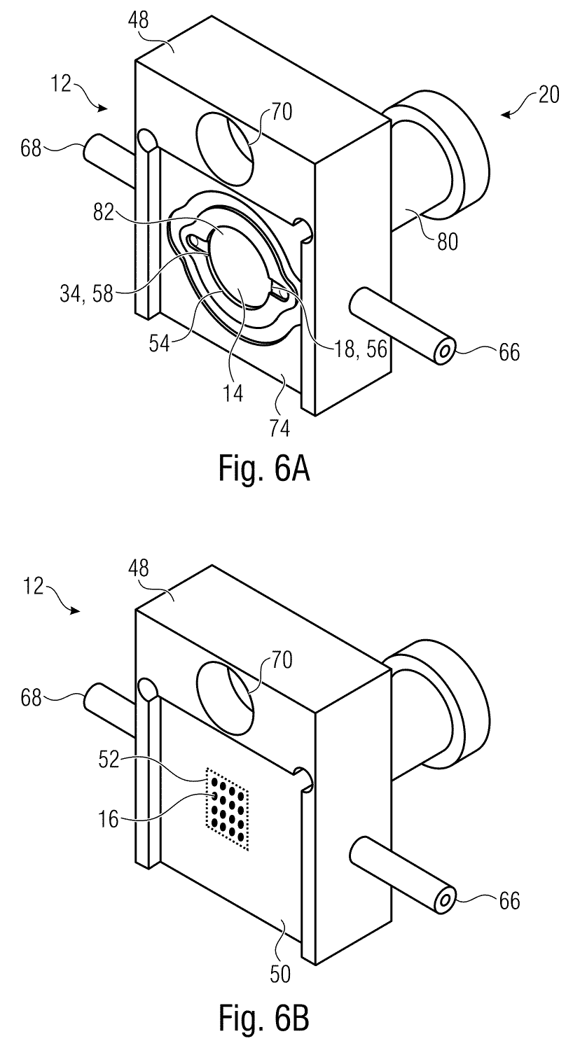

The cartridge 12 has a nozzle chip 72 which is inserted into a nozzle chip receiving opening (see, for example, nozzle chip receiving opening 74 FIG. 6a) of the cartridge body 48. The nozzle chip 72 forms or contains the nozzle wall 50.

The cartridge body 48 has receiving structures 76 which are configured to receive attachment structures 78 of the nozzle chip 72. The attachment structures 78 can mechanically grip the receiving structures 76 (e.g. by means of a latching structure). Alternatively or additionally, the receiving structures 76 may be connected to the attachment structures 78 by means of an attachment means (e.g. adhesive and/or screws). The cartridge 12 may have a seal (e.g. a rectangular sealing ring) which seals the nozzle chip 72 with respect to the cartridge body 48. The nozzle chip 72 may be fixedly connected to the cartridge body 48 (e.g. as part of a manufacture of the cartridge 12) or may be detachably connected to the cartridge body 48 (e.g. to allow a user to connect the cartridge body 48 to different types of nozzle chips 72).

FIG. 5b shows an example of a nozzle wall 50 with twenty nozzles 16 which are arranged in a array with five rows of four nozzles 16. The nozzles 16 are thus arranged in a nozzle region 52 with a rectangular shape. However, the nozzle wall 50 may have any other number of nozzles (as described herein) in any other arrangement in a nozzle region 52. The number of nozzles 16 may, for example, be in a range from 2 to 1000, e.g. in a range from 10 to 500, e.g. in a range from 50 to 200, e.g. in a range of several dozen nozzles 16.

FIG. 6a shows a perspective view of a cartridge 12 according to a further example, in which the nozzle wall is removed for clarity. FIG. 6a therefore allows a view into a dosing chamber 14 of the cartridge 12. In the example shown in FIG. 6a, an actuator 20 with a plunger 80 is also shown (each of which need not be a part of the cartridge 12). The plunger 80 has an (e.g. flat) end face 82 which is directed towards the nozzle wall (not shown in FIG. 4a).

The plunger 80 is received in a recess 54 of the cartridge body 48. A first and second opening 56, 58 are configured in a side wall of the recess 54 which respectively form a fluid inlet 18 and a fluid outlet 34. The fluid inlet 18 and the fluid outlet 34 are each fluidically connected to a first hose connection 66 and a second hose connection 68.

The end face 82 of the plunger 80, the side face of the recess 54 and the nozzle wall 50 delimit a part of the dosing chamber 14, wherein the delimitation is open at least at the fluid inlet 18, the (optional) fluid outlet 34 and the nozzles 16. The volume of the dosing chamber 14 can be changed by the actuator 20, for example by moving the plunger 80 within the recess 54. A reduction in volume (e.g. caused by a movement of the plunger 80 towards the nozzle wall 50) can cause a liquid in the dosing chamber 14 to be ejected from the nozzles 16.

FIG. 6b shows a perspective view of the cartridge 12 from FIG. 6a with a nozzle wall 50.

The nozzle wall 50 has a plurality of nozzles 16 which are arranged within a nozzle region 52. In the example shown in FIG. 6b, the nozzle wall 50 has sixteen nozzles 16 in a nozzle region 52, in which the nozzles 16 are arranged in a square arrangement with four nozzles on each side. Alternatively, the nozzle wall 50 may have any other number of nozzles in any other nozzle region 52 as described herein. The number of nozzles 16 may, for example, be in a range from 2 to 1000, e.g. in a range from 10 to 500, e.g. in a range from 50 to 200, e.g. in a range of several dozen nozzles 16.

The cartridge 12 has a cartridge body 48 which has an attachment opening 70. Alternatively, the cartridge 48 may have more than one attachment opening 70. Furthermore, the cartridge 12 has two hose connections 66, 68 which are each fluidically coupled to the fluid inlet 18 and the fluid outlet 34. The hose connections 66, 68 are arranged on opposite sides of the cartridge body 48, but may be arranged on any other (or even the same) side of the cartridge body 48.

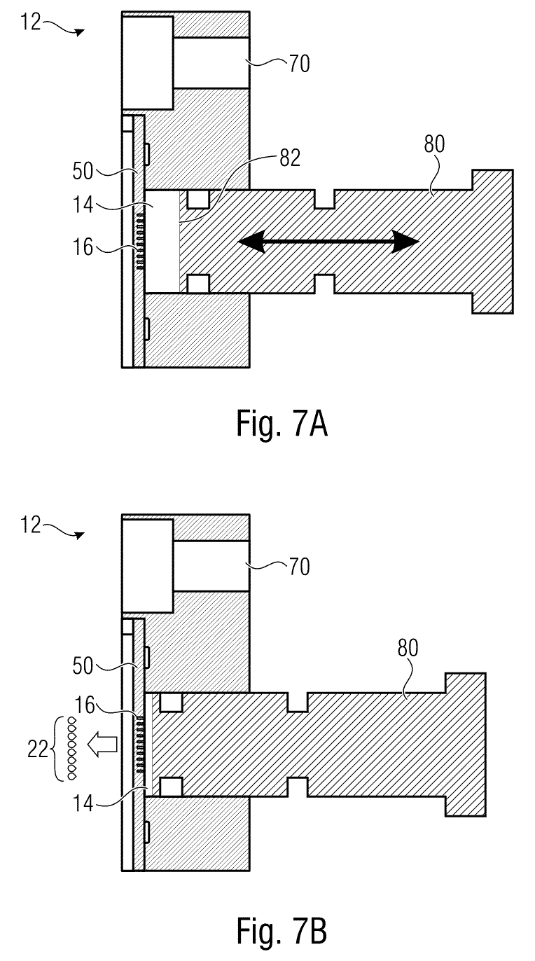

FIG. 7a shows a schematic cross-section through the cartridge of FIGS. 6a, b, wherein the plunger 80 is arranged in an extended position.

FIG. 7b shows a schematic cross-section through the cartridge of FIGS. 6a, b, wherein the plunger 80 is arranged in an retracted position.

In the extended position, a distance (and thus a volume of the dosing chamber 14) between the nozzle wall 50 and the end face 82 of the plunger 80 is greater than in the retracted position. A liquid in the dosing chamber 14 can therefore be ejected from the nozzles 16 in the form of droplets 22 by moving the plunger in the direction of the dosing wall 30 (e.g. into the retracted position). The actuator 20 may be configured to deform the volume of the dosing chamber 14 in a deformation process, wherein the volume of the dosing chamber 14 is increased one time and reduced one time. The actuator 20 may be configured to deform the volume of the dosing chamber 14, wherein in a deformation process (substantially) one droplet is ejected per nozzle (e.g. wherein over 90 % of the liquid ejected from a nozzle 16 in a droplet dispensing process is contained in the same droplet).

A kinetic energy introduced into the liquid by a velocity of the actuator movement or plunger movement enables a liquid portion ejected through the nozzles 16 to be detached as individual liquid droplets 22. The velocity of the actuator movement or plunger movement can be in the order of size required to overcome the surface tension of the liquid to be dosed by kinetic energy input into the liquid and to physically enable the detachment of individual droplets 22 (e.g. one droplet per nozzle 16).

The ejection of the droplets 22 from the plurality of nozzles 16 may be realised by the movement of a single plunger (or actuation of a single actuator 20) in the dosing chamber 14. The use of a single actuator 20 for a plurality of nozzles 16 instead of a plurality of actuators (e.g. one actuator for each nozzle) facilitates the realisation of the same operating conditions such as pressure, stroke speed and actuation frequency for the plurality of nozzles 16. Consequently, a variation of the droplet quantity, the droplet shape and the rejection time can be reduced. The design is also less complex compared to a large number of actuators to be coordinated.

FIGS. 6a to 7b show a cartridge 12 in which the nozzle wall 50 is formed in a nozzle chip 72. However, the nozzle wall may also be a part of the cartridge body 48. For example, the nozzle wall 50 may be formed in one piece with the cartridge body 48.

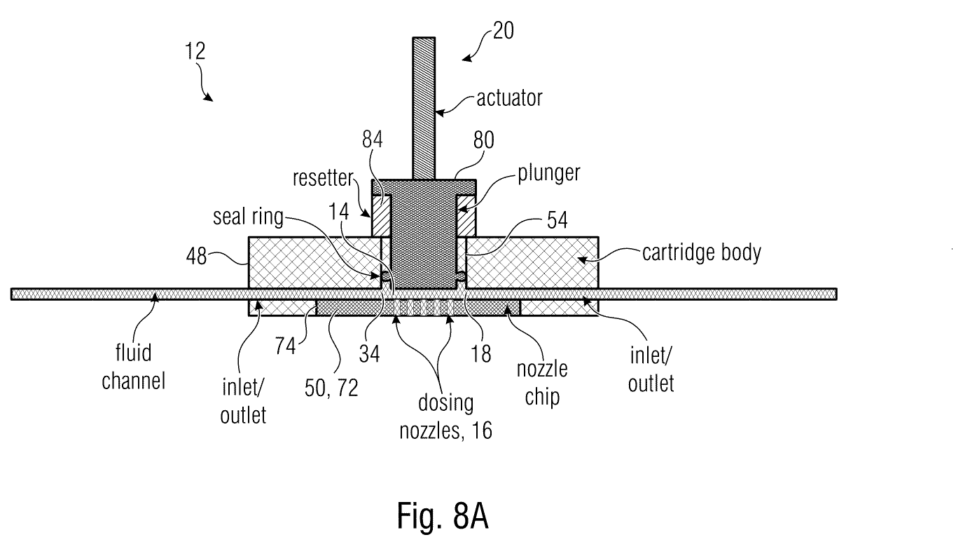

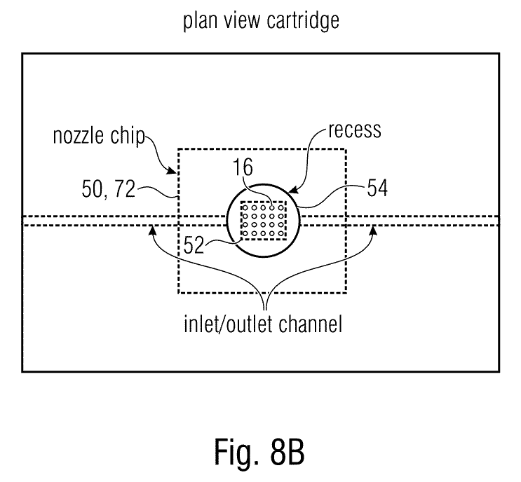

FIG. 8a shows a schematic cross-section of an example of a cartridge 12 for dispensing droplets from a plurality of nozzles 16.

The cartridge 12 comprises a cartridge body 48, a nozzle wall 50 with a plurality of nozzles 16 which are arranged in a nozzle region of the nozzle wall 50, wherein the nozzle wall 50 is formed in a nozzle chip 72 which is inserted into a nozzle chip receiving opening 74 of the cartridge body 48.

The cartridge 12 has a recess 54 which extends from a surface opposite the nozzle wall 50 to the nozzle region through the cartridge body 48 to expose recess side ends of the nozzles 16, wherein the recess 54 is configured to receive an actuator 20 and to define a dosing chamber 14 with the actuator. The cartridge 12 comprises a fluid inlet 18 which is fluidically connected to a first opening in a side wall of the dosing chamber 14 (e.g. the recess 54), and a fluid outlet 34 which is fluidically connected to a second opening in the side wall 42 of the dosing chamber 14 (e.g. the recess 54). The cartridge 12 is therefore configured in accordance with the first variant described above with reference to FIG. 3a. However, the cartridge 12 may also be configured according to the second variant with a deformable delimitation 86 (see, for example, FIG. 3b).

The actuator 20 (or, alternatively, the cartridge 12) has a resiliently deformable resetter 84 which is arranged or can be arranged between a flange of the actuator 20 (e.g. the plunger 80) and the cartridge 12 (e.g. the cartridge body 42). When the plunger 80 moves in the direction of the nozzle wall 50, the resetter 84 is configured to be compressed and to generate a force on the plunger 80 that counteracts this movement. The resetter 84 can cause the plunger to move out completely or partially (e.g. together with the actuator 20). Alternatively or additionally, the resetter 84 can define a resonant frequency of the actuator 20 (e.g. in a range of 50 Hz to 100 Hz).

FIG. 8b shows a top view of the nozzle wall 50 of the cartridge 12 from FIG. 6a (viewed from the side facing away from a dosing chamber 14).

In this example, the nozzle chip 72 has twenty nozzles 16 which are arranged in four rows of five nozzles each. The nozzles 16 are arranged in a rectangular nozzle region (or nozzle window) 52. A circular cross-section of the recess 54 is shown in the top view. The area of the cross-section of the recess 54 is 2.7 times as large as an area of the nozzle region 52.

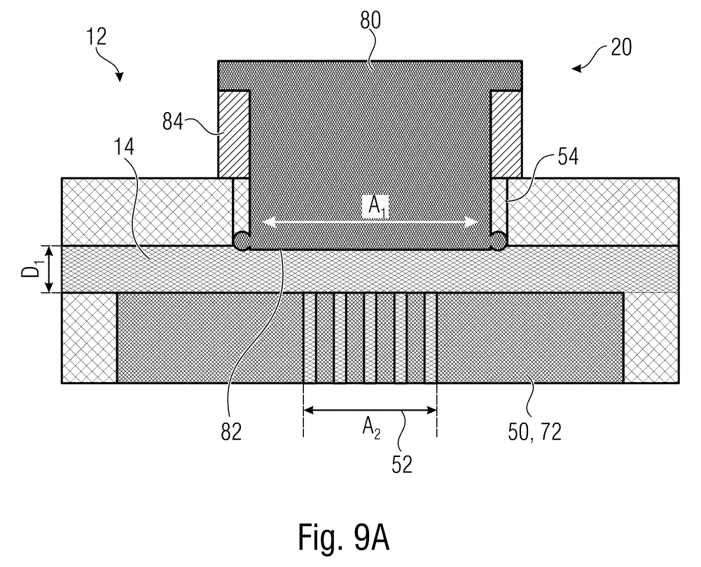

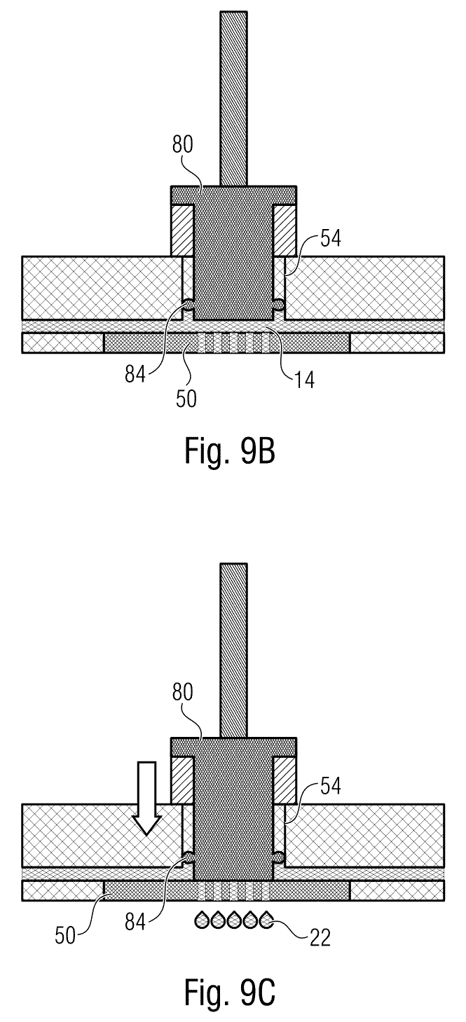

FIG. 9a shows a schematic cross-section of an example of a cartridge 12 with an actuator 20.

The actuator 20 has a (e.g. cylindrical) plunger 80 which is received in a recess 54 in a cartridge body 48 of the cartridge 12. The actuator 20 is configured to change the volume of the dosing chamber 14 by means of a movement of the plunger 80.

The cartridge 12 comprises a plurality of nozzles 16 which are arranged in a nozzle region 52 of a nozzle wall 50 of the dosing chamber 14 and the plunger 80 with the end face 82, wherein the area of the end face 82 is larger than the area of the nozzle region 52. In FIG. 9a, the area of the end face 82 of the plunger 80 A₁ is shown to be larger than the area A₂ of the nozzle region 52. For example, the area A₁ may be at least 2.7 times as large as the area A₂. For example, the area A₂ may have a size in a range from 3 mm² to 12 mm², advantageously in a range from 6 mm² to 8 mm². Alternatively or additionally, the area A₁ may have a size in a range from 9 mm² to 31 mm², advantageously in a range from 15 mm² to 25 mm². The area A₁ may be more than 2.7 times as large (e.g. three, four or five times as large) as the area A₂.

The end face of the plunger 80 and the nozzle wall 50 are spaced apart from one another by a distance in the range from 50 µm to 2000 µm, advantageously in the range from 200 µm to 600 µm. The distance between the end face of the plunger 80 and the nozzle wall 50 may be 400 µm, for example.

The plunger 80 is configured to be deflected or moved in a range of 0.5 µm to 50 µm, for example in a range of 1 µm to 35 µm. The actuator 20 is configured to change the volume of the dosing chamber 14 in a range of 1 nanoliter to 1500 microliters, e.g. 20 nanoliters to 700 microliters. The actuator 20 is configured to limit the deflection on the basis of at least one of the mechanics of a motor (e.g. maximum possible deflection of an electric motor or of piezoelectric elements), control signals for the motor of the actuator 20 and the resetter 84 (e.g. by selecting a spring constant of a spring or a degree of hardness of a polymer). The plunger 80 is configured to be moved at a maximum speed of 5 µm/ms to 500 µm/ms (e.g. 50 µm/ms to 200 µm/ms). The plunger 80 may, for example, be configured to cover a sinusoidal path in terms of time. Such plunger speeds can (e.g. depending on a plunger geometry) physically enable a kinetic energy input into the liquid to overcome the surface tension of the liquid to be dosed (e.g. medium) and the detachment of individual droplets (one droplet per nozzle opening).

The nozzles 16 may have a cross-section in the form of a circle, an oval, a rectangle, a square or a polygon. The nozzles 16 may have a constant cross-section (e.g. in a range of 10 µm to 500 µm, e.g. in a range of 50 µm to 200 µm). Alternatively, the nozzles may have portions with different cross-sections (e.g. as described herein with reference to FIG. 2a). For example, the plurality of nozzles 16 on a side facing away from the dosing chamber 14 may each have a diameter in a range of 0.01 mm to 0.5 mm, advantageously in a range of 0.03 mm to 0.1 mm. Alternatively or additionally, the plurality of nozzles 16 may each have a diameter in a range of 0.01 mm to 0.5 mm, advantageously in a range of 0.1 mm to 0.2 mm, on a side facing the dosing chamber 14.

FIG. 9b shows a schematic cross-section through an example of a cartridge 12 from FIG. 8a, wherein the plunger 80 is arranged in an extended position.

FIG. 9c shows a schematic cross-section through an example of a cartridge 12 from FIG. 8a, wherein the plunger 80 is arranged in an retracted position.

The dosing volume 14 is (at least partially) delimited by the plunger 80, the recess 54 and the nozzle wall 50 (as well as by optional smaller surfaces such as an optional seal 68). The volume of the dosing chamber 14 can therefore be changed by moving the actuator 20 (or its plunger 80).

When the plunger 80 is moved in the direction of the nozzle wall 50, the volume in the dosing chamber 14 is reduced and a liquid in the dosing chamber 14 can be discharged from the nozzles 16 in the form of droplets 22. The plunger 80 is sealed with respect to the recess 54 by means of a seal 84 (e.g. by means of an O-ring). The seal 84 may be fixed (e.g. bonded) or locked (e.g. received in a groove) to the plunger 80 or to the recess 54. Consequently, the plunger 80 may form a part of the delimitation of the dosing chamber 14, wherein the seal 84 may reduce leakage of the liquid between the plunger 80 and the recess 54.

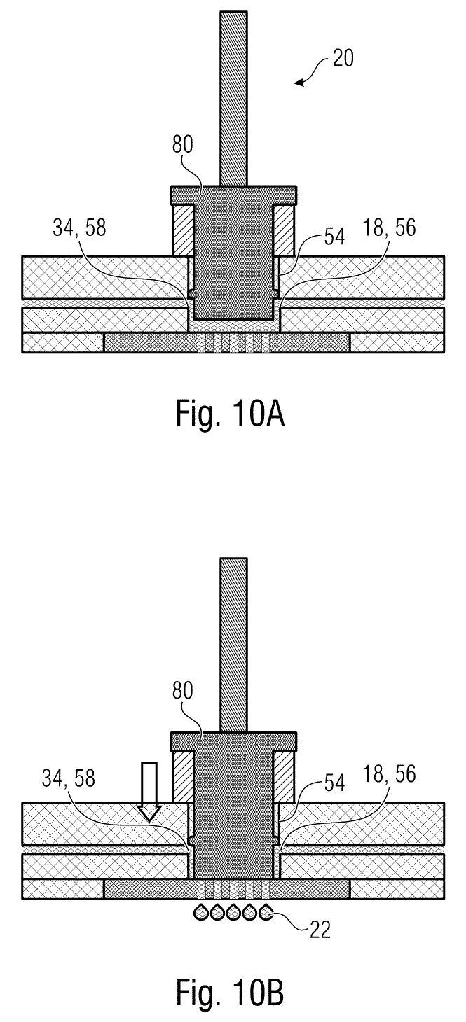

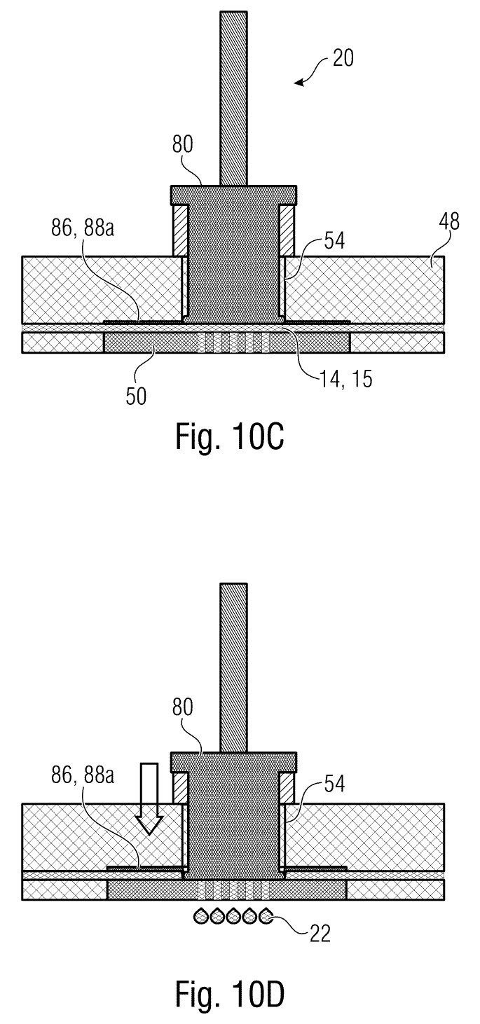

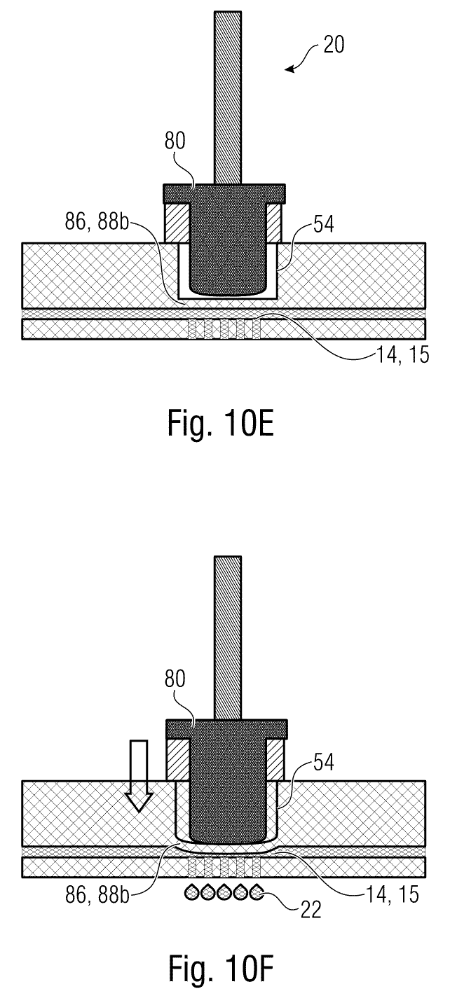

FIG. 10a shows a schematic cross-section through an example of a cartridge 12 with openings 56, 58 spaced from the nozzle wall 50.

The cartridge 12 has first and second openings 56, 58 (or a fluid inlet 18 and a fluid outlet 34) in a side wall of a recess 54 that are spaced apart (e.g. spaced between 0.1 mm to 1 mm apart) from a nozzle wall 50. The plunger 80 of the actuator 20 may have a lateral surface (e.g. a lateral surface of a cylindrical plunger) towards which the first and/or second openings 56, 58 are directed (e.g. in any position of the actuator 20 or at least in a position of the actuator 20 close to the nozzle wall 50).

When the actuator 20 (e.g. the plunger) is moved toward the nozzle wall 50, the plunger may partially or completely cover the first and/or second openings 56, 58 such that a fluidic resistance between the first and/or second openings 56, 48 and the dosing chamber 14 is increased. Consequently, displacement of the liquid through the first and/or second openings 56, 48 (in favour of displacement of the liquid through the nozzles 16) may be reduced.

In FIG. 10a, the plunger 80 is in an extended position, in which the plunger 80 already covers the openings 56, 58. Alternatively, the plunger 80 may not or only partially cover the openings 56, 58 in the extended position.

FIG. 10b shows a schematic cross-section of the cartridge 12 of FIG. 10a, wherein the plunger 80 is arranged in a retracted position.

The plunger covers the two openings 56, 58 so that the fluidic resistance between the dosing chamber and the openings 56, 58 is reduced or disappears. Consequently, a displacement of a liquid through the openings 56, 58 can be reduced or avoided.

As an alternative to a spaced arrangement, the openings 56, 58 may be adjacent to the nozzle wall. The openings 56, 58 may, for example, each have an inner surface which is aligned with a surface (facing the recess 54) of the nozzle wall 50 (as schematically indicated in FIG. 2a, for example).

Features and embodiments of the cartridge 12 described herein using examples of the first variant (e.g. with reference to FIGS. 4a to 10b) are equally applicable to cartridges 12 of the second variant (and vice versa).

FIG. 10c shows a schematic cross-section through an example of a cartridge 12 of the second variant which has a deformable delimitation 86 with a diaphragm 88a. The delimitation 86 may have the diaphragm 88a or be formed by it.

The diaphragm 88a delimits at least a part of the dosing chamber 14. The diaphragm 88a may, for example, completely span a cross-section of the recess 54. In the example shown in FIG. 10a, the cartridge body 48 has a cavity on a side facing the nozzle wall 50 which surrounds the recess 54. The diaphragm 88a is attached to a surface of the cavity facing the nozzle wall 50. The diaphragm 88a can seal the recess 54 fluid-tight against the dosing chamber 14. Therefore, the diaphragm 88a can prevent a liquid from escaping from the dosing chamber 14 into the recess 54. The diaphragm 88a may comprise or consist of rubber and/or a polymer. The diaphragm 88a delimits a chamber structure 15 which in turn forms the dosing chamber 14.

The actuator 20 is configured to deform the diaphragm 88a in order to change the volume of the dosing chamber 14. FIG. 10b shows the actuator 20 (or its plunger 80) in an extended position. In this position, the plunger 80 does not contact the diaphragm 88a, contacts the diaphragm 88a without deforming it, or contacts the diaphragm 88a with a pre-deformation (which is less than in an retracted position of the plunger 80).

FIG. 10d shows a schematic cross-section through an example of a cartridge 12 from FIG. 10c, wherein the actuator 20 (or its plunger 80) is arranged in an retracted position. The actuator 20 deforms the diaphragm 88a in such a way that the volume of the dosing chamber 14 is reduced compared to the volume in FIG. 10c. In the example shown in FIG. 10d, the plunger is pushed into the recess 54 until the diaphragm 88a contacts (or almost contacts) the nozzle wall 50. Alternatively, the plunger may be moved only part of a distance to the nozzle wall 50 (wherein a deformation of the diaphragm 88a is greater than the pre-deformation).

Consequently, the volume of the dosing chamber 14 in FIG. 10d is smaller than in FIG. 10c, so that a liquid can be discharged from the nozzles 16 in the form of droplets 22.

FIG. 10e shows a schematic cross-section through an example of a cartridge 12 of the second variant which has a deformable delimitation 86 with a wall element 88b. The delimitation 86 may have the wall element 88b or be formed by it.

The wall element 88b defines at least a part of a chamber structure 15 which in turn forms the dosing chamber 14, wherein the actuator 20 is configured to deform the wall element 88b to change the volume of the dosing chamber 14. The wall element 88b can seal the recess 54 fluid-tight against the dosing chamber 14. Therefore, the wall element 88b can prevent a liquid from escaping from the dosing chamber 14 into the recess 14. The wall element 88b may be formed in one piece with the cartridge body 48 and may, for example, comprise or consist of a polymer. The wall element 88b may have a wall thickness of 0,01 to 1.0 mm.

FIG. 10f shows a schematic cross-section through the cartridge 12 of FIG. 10e, wherein the actuator 20 deforms the wall element 88b. Due to the deformation, a volume of the dosing chamber 14 limited by the wall element 88b is reduced, so that a liquid within the dosing chamber 14 is ejected through the nozzles 16 in the form of droplets 22.

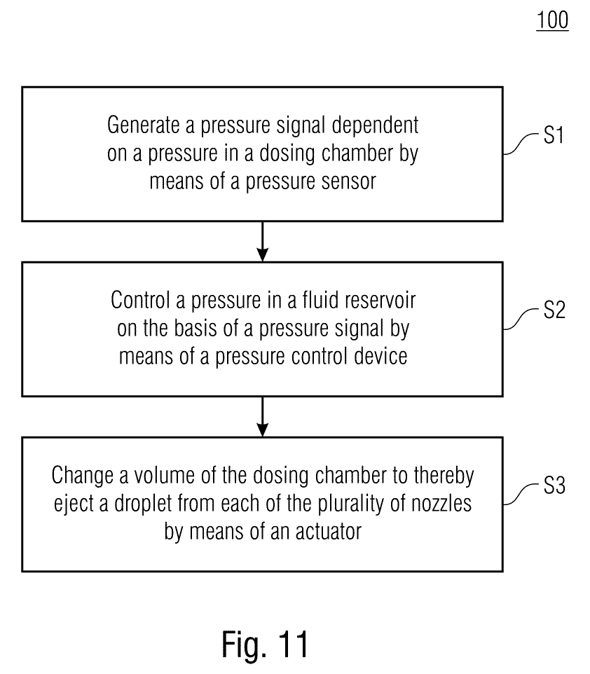

FIG. 11 shows an example of a method 100 for dispensing droplets from a plurality of nozzles of a microdosing device 10 (as shown, for example, in FIGS. 1a to 2b).

The microdosing device 10 comprises a cartridge 12 in which at least a part of a dosing chamber 14 and the plurality of nozzles 16 are formed, wherein the dosing chamber 14 is fluidically connected to a fluid inlet 18 and the plurality of nozzles 16, an actuator 20, a pressure control device 28 provided separately from the actuator 20, a pressure sensor 24 and a liquid reservoir 26 which is fluidically connected to the fluid inlet 18.

In step S1, the method 100 comprises generating, by means of the pressure sensor 24, a pressure signal dependent on a pressure in the dosing chamber 14.

In step S2, the method 100 comprises controlling, by means of the pressure control device 28, a pressure in the liquid reservoir 26 on the basis of the pressure signal.

The method 100 comprises, in step S3, changing, by means of the actuator 20, a volume of the dosing chamber 14 to thereby eject a droplet 22 from each of the plurality of nozzles 16. Ejecting the droplet 22 (or several droplets 22) is caused by the change in volume.

When droplets 22 are repeatedly ejected, the liquid in the liquid reservoir 26 is gradually consumed. Therefore, the height of the liquid column in the liquid reservoir 26 decreases and thus also a hydrostatic pressure that the liquid column exerts on the dosing chamber 14 (due to fluidic connection). The decreasing pressure in the dosing chamber 14 can change the meniscus in the nozzles 16 and thus also the droplet dispension from the nozzles. The pressure control device 28 can compensate for this decrease in pressure, since the pressure control device 28 performs the control on the basis of the pressure signal which is dependent on the pressure in the dosing chamber 14.

The pressure sensor 24 may have a sensor surface which is configured to detect at least one of a gas pressure at the sensor surface and a liquid pressure at the sensor surface. A sensor surface on a gas phase can detect a rapidly changing pressure (e.g. 10 to 100 times per second) more accurately than on a liquid phase. Therefore, a sensor surface on a gas phase can more accurately detect a change in pressure caused by repeated actuation of the actuator 20.

The pressure sensor 24 (or the sensor surface of the pressure sensor 24) can be arranged in the dosing chamber 14. The sensor 20 can directly detect the pressure in the dosing chamber 14. The pressure sensor 24 (or the sensor surface of the pressure sensor 24) may also be arranged outside the dosing chamber 14. The pressure sensor 24 (or the sensor surface of the pressure sensor 24) may, for example, be arranged in (or on) the liquid reservoir 26 (e.g. on a gas phase or liquid phase). The pressure sensor 24 (or the sensor surface of the pressure sensor 24) may be arranged in (or on) a fluid conduit that is fluidically coupled to the dosing chamber 14, as will be discussed in more detail below.

The pressure signal of the pressure sensor 24 may indicate the pressure in pressure units such as bar, Pascal, atm, Torr or psi or in arbitrary units. The pressure signal of the pressure sensor 24 may correspond to the pressure of the dosing chamber 14 (e.g. within a tolerance of ±5 %) or be representative of or dependent on the pressure in the dosing chamber 14. The pressure signal may, for example, correspond to a pressure that is offset and/or rescaled with respect to the pressure in the dosing chamber 14 (e.g. due to a hydrostatic pressure difference and/or a pressure change due to capillary forces). The detected pressure signal may increase or decrease monotonically with the pressure in the dosing chamber 14.

The pressure sensor 24 may be configured to continuously (e.g. with a fixed repetition rate, e.g. of 10 Hz) detect the pressure and generate a pressure signal. Alternatively, the pressure sensor 24 may be configured to generate the pressure signal in response to an external trigger signal (e.g. from the control unit 46 and/or the pressure control device 28) or a predetermined pressure change. The pressure sensor 24 may be configured to send the pressure signal to the control 46 and/or the pressure control device 28.

Controlling the pressure in the liquid reservoir 26 results in controlling the pressure in the dosing chamber 14, since the dosing chamber is fluidically connected to the liquid reservoir 26.

The pressure control device 28 may comprise at least one of a gas pump configured to change a gas pressure in the liquid reservoir 26 and a liquid pump configured to refill liquid into the liquid reservoir 26. A liquid column in the liquid reservoir 26 causes a hydrostatic pressure which acts on the dosing chamber 14 due to fluidic connection. Therefore, the pressure in the dosing chamber 14 can be controlled by refilling liquid into the liquid reservoir 26. The liquid reservoir 26 may form a pressure-resistant container (e.g. by closing an opening of the liquid reservoir 26 with the gas pump). A gas phase above the liquid in the liquid reservoir 26 creates a pressure on the liquid column and therefore also affects the pressure in the dosing chamber 14. Therefore, the pressure in the dosing chamber 14 can be controlled by controlling a gas pressure in the liquid reservoir 26 with the gas pump.

The pressure in the liquid reservoir 26 may be controlled in such a way that the pressure in the dosing chamber 14 and/or the pressure signal of the pressure sensor 24 assumes a target value or is maintained within a target range. The pressure may be controlled by means of a closed-loop pressure control (e.g. by means of a closed control loop with the pressure signal and/or the pressure of the dosing chamber 14 as the controlled variable and the pressure signal as feedback).

Controlling a pressure (e.g. in the dosing chamber 14 and/or the liquid reservoir 26) in such a way that the pressure assumes a target value may comprise counteracting if a detected pressure deviates from the target value. Controlling a pressure so that the pressure is kept within a target range may include counteracting if a detected pressure leaves the target range or threatens to leave the target range.

The target value or the target range for the pressure in the dosing chamber 14 may be predetermined. For example, the target value or the target range for the pressure in the dosing chamber 14 may be determined in advance (e.g. by the manufacturer) for the microdosing device 10 by means of experiments and/or simulations. The target value or the target range for the pressure may be determined depending on different cartridges 12 and/or nozzle walls. The target value and/or the target range may, for example, be determined on the basis of one or more of the following parameters: nozzle diameter, number of nozzles, surface tension of the liquid (e.g. dosing medium), viscosity of the liquid, contact angle of the liquid on an outer side of the nozzle wall 50, contact angle of the liquid in the nozzles 16, stroke and stroke speed of the actuator 20.

Alternatively or additionally, the pressure control device 28 (or a controller 46 of the microdosing device connected to the pressure control device) may be configured to determine and/or adjust the target value or target range for the pressure in the dosing chamber and/or for the pressure signal on the basis of the meniscus signal. The meniscus signal may be used to determine an initial target value or target range (e.g. after filling the dosing chamber 14) and/or to adjust or correct the target value or target range during operation (e.g. after dispensing droplets 22).

The method may comprise controlling, by means of the pressure control device 28, the pressure in the liquid reservoir 26 (and thus indirectly the pressure in the dosing chamber 14), wherein the meniscus signal assumes a target value or an optimum value (e.g. a best possible value if a target value is not reached). For example, the pressure control device 28 may control several pressure values (e.g. from a negative pressure of -5 mbar to a positive pressure of 5 mbar in steps of, for example, 0.1 mbar), wherein the meniscus sensor 44 generates a meniscus signal for all or at least some of the pressure values. A pressure value in the dosing chamber 14 (or a pressure value in the liquid reservoir 26) for which the meniscus signal assumes a target value or an optimum value may be defined as the target value for the pressure in the dosing chamber 14 (also referred to herein as "working pressure"). For example, a pressure range around the target value may be defined as the target range, wherein a size of the target range may be defined as absolute (e.g. ±0.1 mbar) or relative (e.g. ±0.01 % of the target value). This target value or target range may, for example, be determined as an initial value or range before droplets are ejected (e.g. after filling the dosing chamber 14).

The meniscus signal may indicate whether the meniscus is concave, convex or flat in shape. Alternatively or additionally, the meniscus signal may indicate a degree of curvature of the meniscus. Alternatively or additionally, the meniscus signal may indicate an offset of the meniscus with respect to an outer surface of the nozzle wall 50.

The target value and/or target range may be adjusted or corrected during operation of the microdosing device 10. The meniscus sensor 44 may be configured to repeatedly generate a meniscus signal, for example independently (e.g. at regular time intervals or after a predetermined number of droplet dispensions) and/or in response to an instruction (e.g. in response to an instruction from the pressure control device 28 and/or the control 48). At least one of the meniscus sensor 44, the pressure control device 28 and the control 48 may be configured to determine a deviation from the target value or target range of the meniscus signal on the basis of the meniscus signal. The pressure control device 28 or the control 46 may be configured to adjust the target value and/or target range of the pressure signal or the pressure in the dosing chamber 14 on the basis of the meniscus signal or a deviation (determined by the meniscus sensor 44, the pressure control device 28 or the control 48) from the target value or target range of the meniscus signal. The adjustment may be made directly using an algorithm which, for example, defines a relationship between the deviation and the target value and/or target range. Alternatively or additionally, the pressure control device 28 may be configured (e.g. controlled by the control 46) to control the pressure in the liquid reservoir 26 until a (e.g. repeatedly detected) meniscus signal reaches a target value or optimum value. A pressure signal of the pressure sensor 24 detected for this pressure may be defined as a new or adjusted target value (or define a new or adjusted target range).

A target value for the pressure in the dosing chamber 14 may be used, for example, if the pressure in the dosing chamber 14 is measured directly (for example by means of a pressure sensor 24 the sensor surface of which is arranged inside the dosing chamber 14) or if the pressure in the dosing chamber 14 is measured indirectly (for example by means of a pressure sensor 24 which measures a pressure in the volume 40 or in the liquid reservoir 26) and the pressure in the dosing chamber 14 can be inferred from the pressure signal. However, it is not necessary for an absolute pressure in the dosing chamber 14 to be determined from the pressure signal. For example, it may be sufficient to conclude from the pressure signal that the pressure in the dosing chamber 14 does not change (significantly).

If, for example, the pressure sensor 24 is arranged to detect the pressure at the volume 40 (see, for example, FIGS. 2a or 2b), the pressure signal can serve as the basis for control by means of the pressure control device 28, regardless of whether the absolute pressure in the dosing chamber 14 can be determined from the pressure signal.

Since the volume 40 is fluidically coupled with the dosing chamber 14 and is otherwise closed, a pressure change in the dosing chamber 14 also causes a pressure change in the volume 40. If, for example, the pressure in the dosing chamber 14 drops (e.g. because the height of the liquid column in the liquid reservoir 26 decreases due to repeated ejection of droplets 22), the liquid column in the second fluid conduit 32 drops, since this is supported by the pressure in the dosing chamber 14. This increases the volume of the gas (or a gas bubble) in the volume 40. As the amount of gas remains (essentially) the same, the gas pressure decreases (according to the thermal equation of state of ideal gases: p•V=N•k_{B}T, wherein the temperature remains approximately constant). A reduction in the pressure in the dosing chamber 14 may therefore be detected, for example, via a drop in a gas pressure and/or liquid pressure detected by the pressure sensor 24.

If the pressure signal of the pressure sensor 24 indicates a drop in the pressure in the volume, the pressure control device 28 can increase the pressure in the liquid reservoir 26 to such an extent that the pressure signal from the pressure sensor 24 assumes a target value or is maintained within a target range.

The target value and/or target range for the pressure signal can be determined in the same way as the target value and/or target range for the pressure in the dosing chamber 14 can be determined (see description above). For example, the pressure control device 28 may control different pressure values, wherein the meniscus sensor 44 detects the meniscus and the pressure sensor 24 detects the pressure in the volume 40. The target value for the pressure signal may, for example, be defined as the pressure signal for which the meniscus signal reaches the target value or optimum value.

Thus, the pressure control device 28 is configured to control the pressure in the liquid reservoir 26 on the basis of the pressure signal in such a way that the pressure signal of the pressure sensor assumes a target value or is kept within a target range. As a result, the pressure control 28 is configured to (indirectly) control the pressure in the dosing chamber 14 on the basis of the pressure signal so that the pressure in the dosing chamber assumes a target value or is maintained within a target range.

Control by means of the pressure control device 28 may be possible if the pressure sensor 24 is arranged in the liquid reservoir 26. Since the liquid column in the liquid reservoir 26 generates a hydrostatic pressure which acts on the liquid in the dosing chamber 14, a pressure detected in the liquid in the liquid reservoir 26 may indicate a pressure in the dosing chamber 14. The sensor surface of the pressure sensor 24 may be arranged at or near a bottom of the liquid reservoir 26, wherein a decrease in the height of the liquid column (e.g. due to ejection of droplets 22 from the nozzles 16) results in a reduction of a hydrostatic pressure detectable by the pressure sensor 24. If the pressure sensor 24 detects a decrease in pressure, the pressure control device 28 can control the pressure in the liquid reservoir 26 (e.g. by filling up liquid and/or increasing a gas pressure by means of the gas pump) in order to compensate for the decrease in pressure (e.g. until the pressure signal assumes a target value or is maintained within a target range).

The pressure sensor 24 may be arranged to detect a gas pressure above the liquid column in the liquid reservoir 26. For example, the pressure control device 28 may be configured to fill liquid in the liquid reservoir 26 without (substantially) changing an amount of gas in the liquid reservoir 26 (or change the amount of gas in a known manner that can be accounted for in the pressure measurement). If the amount of liquid in the liquid reservoir 26 decreases, the volume of the gas increases which can be detected by a pressure drop. The pressure control device 28 may, for example, be configured to refill liquid in such a way that the pressure signal of the pressure sensor 24 remains (essentially) constant (optionally taking into account the known change in the amount of gas).

The pressure control device 28 may be configured to control the pressure in the liquid reservoir 26 by means of the gas pump on the basis of the pressure signal from a pressure sensor 24 on the gas phase in the liquid reservoir 28. For example, a gas pressure increase may be determined on the basis of a known density of the liquid, a known initial height of the volume of gas in the liquid reservoir 26, and a cylindrical shape of the liquid reservoir 26 (or generally a known relationship between the volume of gas and a height of the volume of gas). The pressure control device 28 (and/or the control 46) may be configured to determine the reduction in the height of the liquid column and the resulting loss of hydrostatic pressure from a change in pressure and the initial height of the gas volume. The pressure control device 28 may be configured to increase the gas pressure by means of the gas pump in order to compensate for the loss of hydrostatic pressure.

The microdosing device 10 may have more than one pressure sensor 24. For example, the microdosing device 10 may have a gas pressure sensor and a liquid pressure sensor in the same or different volumes (e.g. at least one of the dosing chamber 14, the volume 40, and the liquid reservoir 26).

The volume of the dosing chamber 14 may be changed periodically at a frequency of up to 100 Hz. For example, the change may take place at a frequency of 25 Hz to 75 Hz or 40 Hz to 60 Hz. Changing the volume may comprise a predetermined number of periods of movement of the actuator 20 (or its plunger 80), after which the movement of the actuator is interrupted. The droplets 22 may have a volume of 20 picoliters to 200 nanoliters, e.g. 100 picoliters to 50 nanoliters.

The droplets may be ejected in the form of non-contact dosing (jetting). The actuator 20 may therefore be configured to deform the volume of the dosing chamber 14 at a frequency at which the droplets 22 are ejected from the nozzles 16 as free-flying droplets.

The actuator 20 may be configured to dynamically deflect the plunger 80 in order to generate a pressure pulse in the liquid.

The pressure control device 28 may be configured to control the pressure in the liquid reservoir 26 during an ejection of the droplets, so that the pressure is controlled during actuator operations and between two actuator operations. Therefore, it is possible to provide a target meniscus (or optimised meniscus) for continuous (or repeated) ejection of droplets 22. In many cases, actuating the actuator 20 (especially with deflections of less than 50 µm) does not generate a significant change in pressure which would have a considerable effect on the pressure signal. Therefore, ejection of droplets 22 and regulation of the pressure in the liquid reservoir 26 may take place independently of each other.

The method 100 may comprise filling, when the first valve 38 is opened, the dosing chamber 14 with a liquid from the liquid reservoir 26. The method may further comprise opening the second valve 42, if provided. The first and/or second valves 38, 42 may be electrically controlled, wherein the method comprises electrically controlling the first and/or second valves 38, 42. Filling the dosing chamber 14 with the liquid from the liquid reservoir 26 may further comprise controlling, by means of the pressure control device 28, a pressure in the liquid reservoir 26 such that at least a part of the liquid is conveyed into the dosing chamber 14. The pressure control device 28 may, for example, increase a gas pressure above the liquid by means of the gas pump, whereby the liquid is forced into the dosing chamber 14. The method may comprise closing the first valve 38, wherein the first valve 38 may be closed manually or by electrical control. For example, a user may close the first valve 38 as soon as the liquid begins to exit the outlet 36 or when it is visually apparent that the liquid has entered the second fluid conduit 32 (for example, through a viewing window or in the case of a translucent second fluid conduit 32). The first valve 38 may be electrically controlled to close (for example by the pressure sensor 24 or the control 46) if the pressure signal of the pressure sensor 24 exceeds a predetermined threshold value (for example due to hydraulic pressure or a pressure build-up in a gas bubble at the pressure sensor 24).

The dosing chamber 14 may be vented via the nozzles 16 during filling, so that the second fluid conduit 32 is not required. However, the second fluid conduit 32 and the outlet 36 may have larger dimensions than the nozzles 16 so that venting can take place more quickly. Furthermore, potential air bubbles in the liquid may be removed via the outlet 36 instead of via the nozzles 16 (or guided into the volume 40). Air bubbles increase a capacity in the fluidic system and can dampen a direct energy input into the liquid by the actuator (e.g. by compressing the gas in the air bubble). Furthermore, air bubbles may penetrate (or "clog") the nozzles 16 and prevent the nozzles 16 from being wetted and filled. Therefore, transporting air bubbles into the second fluid conduit 32 can improve the energy input and nozzle wetting.

The method may comprise detecting, by means of the pressure sensor 24, a pressure in the closed volume 40 to generate the pressure signal. Alternatively or additionally, the pressure sensor 24 (or a further pressure sensor) may detect a pressure in another volume (e.g. in the dosing chamber 24 and/or the liquid reservoir).

The method may further comprise generating, by means of the meniscus sensor 44, a meniscus signal dependent on a meniscus of one or more nozzles 16, and controlling, by means of the pressure control device 28, the pressure in the liquid reservoir 26 on the basis of the pressure signal and the meniscus signal.

The method may comprise filling the liquid reservoir 26 and optionally closing an opening for filling the liquid reservoir 26. The method may comprise coupling the liquid reservoir 26 to the pressure control device 28, for example by fluidically connecting the gas pump and/or the liquid pump to one or more openings of the liquid reservoir 26. The method may include coupling the liquid reservoir 26 to the fluid inlet 18 (for example, by means of the first fluid conduit 30). For example, the fluid inlet 18 or the first fluid conduit 30 may be fluidically coupled to one or more openings of the liquid reservoir 26. Before coupling, the liquid reservoir 26 may be sealed off from an outside atmosphere (for example by closing all openings of the liquid reservoir 26 to the external atmosphere). This can reduce the risk of unintentional leakage of the liquid into the dosing chamber 14 (for example by forming a negative pressure in the liquid reservoir 26). Furthermore, the second valve 42 (if provided) may be closed. The method may comprise controlling, by means of the pressure control device 28, the pressure in the liquid reservoir 26 so that the liquid fills the dosing chamber 14 (and optionally completely or partially fills the second fluid conduit 32). The pressure control device 28 may, for example, generate a gas pressure of -2 mbar to 2 mbar (compared to an external atmosphere) in the liquid reservoir 26. The gas pressure of the pressure control device 28 may be selected such that bubble formation in the liquid is prevented or minimised (e.g. a gas pressure that causes the liquid to flow along a wall of the liquid reservoir 26 or a continuous laminar liquid jet). The second valve 42 may be opened before filling. The method may comprise interrupting the generation of the gas pressure by the pressure control device 28 and closing the first valve 38.

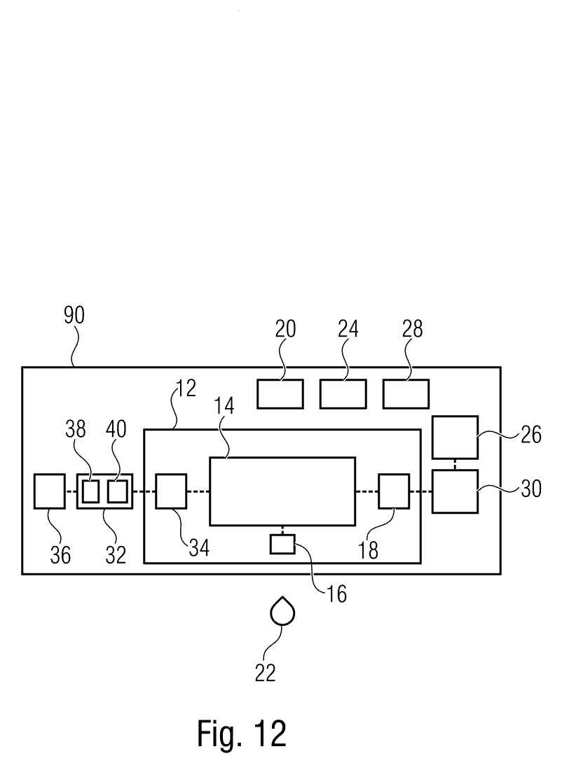

FIG. 12 shows a schematic example of a microdosing device 90 according to the invention for dispensing droplets from a (single) nozzle.

The microdosing device 90 comprises a cartridge 12 in which at least a part of a dosing chamber 24 and the nozzle 16 are formed, wherein the dosing chamber 14 is fluidically connected to a fluid inlet 18 and the nozzle 16. The microdosing device 90 further comprises an actuator 20 configured to change a volume of the dosing chamber 14 to thereby eject a droplet 22 from the nozzle, and a liquid reservoir 26 which is fluidically connected to the fluid inlet 18 by means of a first fluid conduit 30.

The cartridge 12 may comprise (apart from a plurality of nozzles 16) one or more features in any combination of cartridges 12 described herein.

The microdosing device 90 has a second fluid conduit 32, wherein a first end of the second fluid conduit 32 is fluidically connected to the fluid outlet 34 of the dosing chamber 14 and a second end of the second fluid conduit 32 is an outlet 36, wherein a first valve 38 is arranged between the first end and the second end which, when closed, shuts off a flow in the second fluid conduit 32, wherein, when the first valve 38 is closed, a volume 40 fluidically coupled to the dosing chamber 14 and otherwise closed is formed, and wherein the microdosing device 90 has a pressure sensor 24 which is arranged to detect a pressure in the closed volume 40 and to generate a pressure signal dependent on a pressure in the dosing chamber 14.

The first fluid conduit 30, the second fluid conduit 32, the first valve 38, the volume of the second fluid conduit 32, and the pressure sensor may each be implemented as described herein.

The microdosing device 90 has further a pressure control device 28 provided separately from the actuator 20 which is configured to control a pressure in the liquid reservoir 26 on the basis of the pressure signal.

The actuator 20, the pressure control device 28 and the liquid reservoir 26 may each be implemented as described herein.

The pressure control device 28 may be configured to control the pressure in the liquid reservoir 26 on the basis of the pressure signal in such a way that the pressure signal of the pressure sensor 24 assumes a target value or is maintained in a target range.

With the exception of the plurality of nozzles, the microdosing device 90 may have any feature in any combination as disclosed herein with reference to the microdosing device 10 (such as a control 46, a meniscus sensor 44, a first device part 47a, and a second device part 47b). For example, the microdosing device 90 may be implemented as the microdosing device 10 wherein a first cartridge 12 with a plurality of nozzles 16 is decoupled from the microdosing device 10 and the microdosing device 10 is coupled to a second cartridge 12 having only one nozzle 16.

Furthermore, any method steps disclosed herein with respect to the microdosing device 10 are applicable to, or can be performed with, the microdosing device 90 in any combination.

For example, a method for dispensing droplets 22 from the (single) nozzle 16 of the microdosing device 90 according to the invention comprises generating, by means of the pressure sensor 24, a pressure signal dependent on a pressure in the dosing chamber 14, controlling, by means of the pressure control device 28, a pressure in the liquid reservoir 26 on the basis of the pressure signal, and changing, by means of the actuator 20, a volume of the dosing chamber 14 to thereby eject a drop from the (single) nozzle 16.

The method may comprise filling, with the first valve 38 open, the dosing chamber 14 with a liquid from the liquid reservoir 26 and closing the first valve 38. Filling the dosing chamber 14 with the liquid from the liquid reservoir 26 may comprise controlling, by means of the pressure control device 28, a pressure in the liquid reservoir 26 such that the liquid is conveyed into the dosing chamber 14.

The method comprises detecting, by means of the pressure sensor 24, a pressure in the closed volume to generate the pressure signal.

The method may comprise generating, by means of a meniscus sensor 44 of the microdosing device 90, a meniscus signal dependent on a meniscus of the nozzle, and controlling, by means of the pressure control device 28, the pressure in the liquid reservoir 26 on the basis of the pressure signal and the meniscus signal.

The volume of the dosing chamber 14 may be changed periodically at a frequency of up to 100 Hz.

Although features of the invention have been described in each case on the basis of device features or method features, it is obvious to those skilled in the art that corresponding features can also be part of a method or device in each case. Thus, the device may be configured in each case to perform corresponding method steps, and the respective functionality of the device may represent corresponding method steps.

In the preceding detailed description, various features were sometimes grouped together in examples in order to rationalise the disclosure. This type of disclosure is not intended to be interpreted as meaning that the claimed examples have more features than are expressly stated in each claim. Rather, as the following claims disclose, the object may lie in less than all of the features of a single disclosed example. Consequently, the following claims are hereby incorporated into the detailed description, wherein each claim may stand as its own separate example. While each claim may stand as its own separate example, it should be noted that although dependent claims in the claims refer back to a specific combination with one or more other claims, other examples also include a combination of dependent claims with the object of any other dependent claim or a combination of any feature with other dependent or independent claims. Such combinations are included unless it is stated that a specific combination is not intended. It is further intended that a combination of features of a claim with any other independent claim is also encompassed, even if that claim is not directly dependent on the independent claim.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. A microdosing device for dispensing droplets from a plurality of nozzles
which comprises
a cartridge, in which at least a part of a dosing chamber and the plurality of nozzles are formed, wherein the dosing chamber is fluidically connected to a fluid inlet and the plurality of nozzles;
an actuator which is configured to change a volume of the dosing chamber to thereby eject a droplet from each of the plurality of nozzles;
a pressure sensor which is configured to generate a pressure signal dependent on a pressure in the dosing chamber;
a liquid reservoir which is fluidically connected to the fluid inlet;
a pressure control device provided separately from the actuator which is configured to control a pressure in the liquid reservoir on the basis of the pressure signal.

2. The microdosing device according to claim 1, further comprising
a first fluid conduit which fluidically connects the liquid reservoir to the fluid inlet, and
a second fluid conduit, wherein a first end of the second fluid conduit is fluidically connected to a fluid outlet of the dosing chamber and a second end of the second fluid conduit is an outlet which is not fluidically coupled back to the liquid reservoir, wherein a first valve is arranged between the first end and the second end which, when closed, shuts off a flow in the second fluid conduit.

3. The microdosing device according to claim 2,
wherein, when the first valve is closed, a volume is formed which is fluidically coupled to the dosing chamber and is otherwise closed, and wherein the pressure sensor is arranged to detect a pressure in the closed volume.

4. The microdosing device according to claim 2,
wherein the first fluid conduit comprises a second valve which is configured to shut off a flow in the first fluid conduit.

5. The microdosing device according to claim 1,
wherein the pressure control device is configured to control the pressure in the liquid reservoir on the basis of the pressure signal in such a way that the pressure in the dosing chamber and/or the pressure signal of the pressure sensor assumes a target value or is maintained within a target range.

6. The microdosing device according to claim 1, further comprising
a meniscus sensor which is configured to generate a meniscus signal dependent on a meniscus of at least one of the plurality of nozzles,
wherein the pressure control device is configured to control the pressure in the liquid reservoir on the basis of the meniscus signal.

7. The microdosing device according to claim 5,
wherein the pressure control device or a control of the microdosing device connected to the pressure control device is configured to determine and/or adjust the target value or target range for the pressure in the dosing chamber and/or for the pressure signal on the basis of the meniscus signal.

8. The microdosing device according to claim 1,
wherein the pressure control device comprises at least one of
a gas pump which is configured to change a gas pressure in the liquid reservoir, and
a liquid pump which is configured to refill liquid into the liquid reservoir.

9. The microdosing device according to claim 1, further comprising
a plunger, wherein the actuator is configured to change the volume of the dosing chamber by means of a movement of the plunger.

10. The microdosing device according to claim 9,
wherein the plunger comprises a lateral surface and at least one of the fluid inlet and the fluid outlet is directed towards the lateral surface.

11. The microdosing device according to claim 1, further comprising
a diaphragm which delimits at least a portion of the dosing chamber, wherein the actuator is configured to deform the diaphragm to change the volume of the dosing chamber.

12. The microdosing device according to claim 1,
wherein the cartridge comprises a wall element which delimits at least a portion of the dosing chamber, wherein the actuator is configured to deform the wall element to change the volume of the dosing chamber.

13. The microdosing device according to claim 1, further comprising
a first device part which comprises the cartridge with the plurality of nozzles; and
a second device part which comprises the actuator,
wherein the first device part and the second device part are connected to one another in a detachable manner.

14. A method for dispensing droplets from a plurality of nozzles of a microdosing device, wherein the microdosing device comprises a cartridge, in which at least a part of a dosing chamber and the plurality of nozzles are formed, wherein the dosing chamber is fluidically connected to a fluid inlet and the plurality of nozzles, an actuator, a pressure control device provided separately from the actuator, a pressure sensor and a liquid reservoir fluidically connected to the fluid inlet, the method comprising
generating, by means of the pressure sensor, a pressure signal dependent on a pressure in the dosing chamber;
controlling, by means of the pressure control device, a pressure in the liquid reservoir on the basis of the pressure signal; and
changing, by means of the actuator, a volume of the dosing chamber to thereby eject a droplet from each of the plurality of nozzles.

15. The method according to claim 14, wherein the microdosing device further comprises a first fluid conduit which fluidically connects the liquid reservoir to the fluid inlet, and a second fluid conduit, wherein a first end of the second fluid conduit is fluidically connected to the fluid outlet of the dosing chamber and a second end of the second fluid conduit is an outlet which is not fluidically coupled back to the liquid reservoir, wherein a first valve is arranged between the first end and the second end which, when closed, shuts off a flow in the second fluid conduit, the method further comprising
filling, when the first valve is opened, the dosing chamber with a liquid from the liquid reservoir; and
closing the first valve.

16. The method according to claim 15, wherein filling the dosing chamber with the liquid from the liquid reservoir comprises controlling, by means of the pressure control device, a pressure in the liquid reservoir in such a way that the liquid is conveyed into the dosing chamber.

17. The method according to claim 15, wherein, when the first valve is closed, a volume fluidically coupled to the dosing chamber and otherwise closed is formed, the method comprising detecting, by means of the pressure sensor, a pressure in the closed volume to generate the pressure signal.

18. The method according to claim 14, the method further comprising
generating, by means of a meniscus sensor of the microdosing device, a meniscus signal dependent on a meniscus of at least one of the plurality of nozzles, and
controlling, by means of the pressure control device, the pressure in the liquid reservoir on the basis of the pressure signal and the meniscus signal.

19. A microdosing device for dispensing droplets from a nozzle, comprising
a cartridge, in which at least a part of a dosing chamber and the nozzle are formed, wherein the dosing chamber is fluidically connected to a fluid inlet and the nozzle;
an actuator which is configured to change a volume of the dosing chamber to thereby eject a droplet from the nozzle;
a liquid reservoir which is fluidically connected to the fluid inlet by means of a first fluid conduit;
a second fluid conduit, wherein a first end of the second fluid conduit is fluidically connected to the fluid outlet of the dosing chamber and a second end of the second fluid conduit is an outlet, wherein a first valve is arranged between the first end and the second end which, when closed, shuts off a flow in the second fluid conduit, wherein, when the first valve is closed, a volume fluidically coupled to the dosing chamber and otherwise closed is formed, and wherein the microdosing device comprises a pressure sensor which is arranged to detect a pressure in the closed volume and to generate a pressure signal dependent on a pressure in the dosing chamber;
a pressure control device provided separately from the actuator which is configured to control a pressure in the liquid reservoir on the basis of the pressure signal.

20. The microdosing device according to claim 19,
wherein the pressure control device is configured to control the pressure in the liquid reservoir on the basis of the pressure signal in such a way that the pressure signal of the pressure sensor assumes a target value or is maintained within a target range.
